(19) United States
(12) Patent Application Publication
(10) Pub. No.: US 2026/0063366 A1
(43) Pub. Date: Mar. 5, 2026

(54) APPARATUS AND METHOD FOR ROTARY FURNACE FLAME CONTROL TO MELT METAL

(71) Applicant: Air Products and Chemicals, Inc., Allentown, PA (US)

(72) Inventors: Eric R. Seo, Bowmanstown, PA (US); Reed Jacob Hendershot, Mesa, AZ (US); Anandkumar Makwana, Breinigsville, PA (US); Valmiro Correia Sa, Magnolia, TX (US)

(73) Assignee: Air Products and Chemicals, Inc., Allentown, PA (US)

(21) Appl. No.: 18/911,011

(22) Filed: Oct. 9, 2024

Related U.S. Application Data
(60) Provisional application No. 63/687,814, filed on Aug. 28, 2024.

(51) Int. Cl. F27D 19/00; F27D 21/00

(52) U.S. Cl. CPC F27D 19/00; F27D 21/00

(57) ABSTRACT

Source: FR2832733 A1 Video sensors are used for controlling melting of aluminum in a furnace by producing images of the bath surface or the inner surface of the furnace walls. Melting of aluminum in a furnace comprises: (a) introducing solid aluminum into the furnace; (b) melting the aluminum to form a molten bath; (c) production of images of the bath surface or of the inner surface of the furnace (2) walls; (d) treating these images to identify the presence of solids or the formation of oxides on the bath surface or for identifying the presence of hot spots or hot zones or zones having a certain minimal temperature on the fumace walls; and (e) modifying at least one fumace operating condition as a function of this treatment of the images. Independent claims are also included for the following: (a) a device for detecting the surface state of a bath of aluminum or the state of the furnace walls in an aluminum melting furnace; and (b) an aluminum melting furnace incorporating this detection device.

### CROSS-REFERENCE TO RELATED APPLICATIONS

The present application claims priority to U.S. Provisional Patent Application No. 63/687,814, filed on Aug. 28, 2024. The entirety of this provisional patent application is incorporated by reference herein.

### FIELD OF THE INVENTION

The present innovation relates to processes and apparatuses to melt metal (e.g. rotary furnaces, etc.) and processes and apparatuses to control flame(s) for the melting of metal (e.g. melting of scrap aluminum or other scrap metal, etc.).

### BACKGROUND OF THE INVENTION

Furnaces can often use burners to generate flames. The heat provided via the burners can be used in various industrial processes. For example, reverberatory furnaces and rotary furnaces can often use one or more burners for heating metal to melt the metal. Examples of furnaces and burners can be appreciated from U.S. Pat. App. Pub. Nos. 2019/0360067 and 2021/0116125 and U.S. Pat. Nos. 4,484,947, 7,390,189, 8,696,348, 8,727,767, 8,806,897, 9,134,025, 9,360,257, 9,657,945, 9,689,312, 9,976,721, 10,584,051, 11,441,206, 11,598,522, and 11,740,022.

### SUMMARY OF THE INVENTION

We determined that burner operation and furnace operation for the melting of metal can result in overheating of the metal or the burning of the metal. This can occur, for example, during a remelt operation for melting of scrap, melting of metal for recycling of the metal, melting of aluminum scrap for recycling of the aluminum, or other types of metal melting applications. Burning of metal (e.g. aluminum) can result in oxidation of the metal. For instance, in melting of aluminum, if the metal is oxidized, the aluminum (Al) can be converted to alumina (Al₂O₃), which can result in a loss of yield and increased waste. The decrease in operational efficiency and lost yield can also result in lower profitability associated with operation of a melting process.

For example, in a rotary furnace utilized for aluminum recycling, yield recovery and energy costs can be significant factors that affect furnace operational efficiency and productivity. Yield recovery for aluminum recycling can be the amount of aluminum obtained from melting scrap material that includes aluminum. If the scrap is overheated either overall or in specific areas, this can burn the aluminum causing oxidization and converting it to alumina, which results in a loss of yield, increased waste, and lower profitability. The input energy used to cause this loss in yield could also increase the total energy costs and results in the less efficient utilization of heat, which can result in an increased environmental impact associated with operation of a furnace.

We determined that it can be beneficial to control operation of a rotary furnace so that flame(s) output by one or more burners of the rotary furnace can be controlled to provide greater flexibility in operation of the furnace for a more refined control of melting of metal to help avoid burning the metal while also improving utilization of energy so that a more efficient and flexible operation of the furnace can be provided in a way that may also improve the environmental impact related to operation of the furnace and the melting of metal.

Embodiments of a furnace, a rotary furnace, a process for melting metal material, a process for controlling burner operation in a rotary furnace, process for controlling burner operation in a furnace, and a control system for melting of metal material via a furnace, a rotary furnace and/or a metal melting process can be provided. Embodiments can facilitate improved operation of one or more burners to account for a material state of the metal material being melted to more effectively utilize heat generated via combustion of a fuel provided via the burner(s). Embodiments can provide enhanced operational flexibility as well as improved operational efficiency, which can also permit operations to occur in a more environmentally friendly way.

The burners that may be utilized in the furnace can be any type of suitable burner. For example, burners, oxy-fuel burners, transient burners with multiple burner elements wherein each burner element can output a respective flame, or a combination of such burners can be utilized. Some embodiments may utilize a single burner while other embodiments may utilize multiple burners (e.g. at least two burners, a pair of burners, at least three burners, etc.).

The metal material to be melted can be aluminum or another type of metal or can be an alloy (e.g. brass or bronze). For example, the metal material can be copper, lead, tin, brass, steel, iron, or other suitable metal material instead of aluminum.

In some embodiments, improved heat distribution throughout the rotary furnace with increased heat transfer can be provided when the metal material is still solid in a first operational cycle. For example, at least one flame output from at least one burner can be directed to the metal material to contact the metal material to help provide a higher transfer of heat to the metal material more quickly to initiate melting of the metal material while also avoiding the burning of the metal material. In some embodiments, the flame(s) output from the burner(s) can be provided to provide improved heat distribution throughout the furnace with increased turbulence close to the surface of the metal material to improve heat transfer with the metal material while it is in a solid state. The heating of the metal material in the furnace can occur in a rotatable chamber. As the burner(s) output at least one flame, the chamber can be rotated with the metal material within the chamber being exposed to the flame(s) for being heated. The chamber can be rotated at a pre-selected rotational speed during the melting of the metal material via an actuator (e.g. rotational drive mechanism that can include an actuator, rotational drive device, at least one hydraulic actuator, etc.)

As the metal material increases in temperature a material state change can occur (e.g. for aluminum, the material state change can occur around 660° C., etc.). This change in the state of the metal material can affect the amount of resistance the metal material can provide to the rotation of the chamber of the furnace. For example, when the metal material is solid, it will have a higher average friction and a resistance to rotation of the chamber than when it is molten or liquid. This change in resistance can be detected via motor current, hydraulic pressure, hydraulic motor current, and/or other parameter related to the power required to rotate the chamber. A change that exceeds a pre-selected threshold, for example, can be detected to identify a sufficient change in the state of the metal material to indicate that the burner operation should be adjusted to avoid overheating of the metal material and possible burning of the metal material. For example, in response to a detection of a sufficient change in the resistance to rotation of the chamber of the furnace, the operation of the burner(s) can be adjusted to move at least one flame away from the metal material, lower a firing rate of the burner(s), switch off some of the burners while at least one burner remains active, and/or other burner operational parameter to adjust the heat distribution in the chamber so the metal material is heated less aggressively after the material state change is detected to help avoid burning of the metal material. We have found that such an operational approach can permit metal material to be melted more quickly with higher efficiency while also avoiding waste due to metal burning. For example, we have found that embodiments can reduce or avoid overheating of metal material, reduce cycle time for a melt operation for a batch of metal material, and reduce energy wasted in overheating of the metal material. These types of improvements can provide greater operational flexibility to account for the condition of the metal material being melted, reduce waste production, improve time savings in operation, and increase yield in recovery.

For example, burner operation can be adjusted so that each of the burners is operated so that heat energy continues to enter the furnace's chamber during the melting operation, but a high flame velocity is removed from the surface of the material to reducing the surface rippling and reduce oxidation of the liquid aluminum or other metal by reducing mixing and heat flux. In embodiments that utilize flame movement, the flame movement can be mechanical, or valve operated. The movement of the flame(s) can reduce over heating of the metal material (e.g. avoid burning of the metal), reduce surface rippling, reduce cycle time, and reduce energy wasted in overheating the material leading to an increase in yield recovery, reduced waste production, and improved time savings (e.g. allowing a melting operation to occur more quickly).

In some embodiments, scrap metal material can be initially heated in a first cycle of operation via at least one burner outputting at least one flame (e.g. via combustion of a fuel in the presence of an oxidant) at a first firing rate, which can be set to be a high firing rate. This can help improve heat distribution throughout the furnace with increased heat transfer by convection surface turbulence occurring when the metal material is still solid. As the material increases in temperature a material state change can occur. For aluminum, the state change may occur around 660° C. (e.g. 660° C.+/−25° C.) or at 660° C., for example, depending on the alloy. With continued heating during this first operational cycle, the metal material can melt into a more molten state that can reduce the resistance the metal material provides to the rotation of the chamber of the furnace driven by a motor or other type of rotational actuator.

Once this change in condition of the metal material is detected (e.g. via at least one sensor or via a detector that can detect a change in current, voltage, hydraulic pressure and/or power applicable to the motor or other actuator driving rotation of the chamber, etc.), a material state change can be determined to have occurred and the operation of the burner(s) can be adjusted to a second cycle of operation. For example, after this material state change is detected, the burner(s) can be adjusted to change the firing rate of the burner(s), adjust the flame position away from the metal material, and/or adjust other burner operational parameters to reduce the rate of heating being applied to the metal material via the flame(s) of the burner(s). This adjustment can be provided so that the burner(s) operate in the second cycle of operation until the metal material is fully melted. For example, this adjustment could result in moving the flame(s) from near the back of the chamber to closer to the front of the chamber, moving the flame(s) away from the metal material, shortening a flame closer to the metal material and elongating a flame positioned farther away from the metal material in the chamber, and/or any combination of these movements until the cycle is complete and the metal material is melted and or heated to its desired temperature. Heat energy can continue to enter the furnace via the flame(s) but the flame position adjustment and/or number of flames being output can permit the distribution of the heat and the flame positioning to reduce oxidation of the liquid aluminum or other metal charge material. In embodiments that utilize flame movement, the flame movement can be mechanical or valve operated with movement in any desired direction depending on the burner position for each burner and the detected state or position of the metal material being melted as noted above.

The second cycle of operation in which the burner(s) operation is adjusted can be performed until the metal material is fully melted into a liquid or can be performed until another detected state change has occurred in which the metal material is detected as being further melted to another molten state that is more liquified, but not yet fully liquid metal. In response to such a detected change, which can occur via at least one sensor or via detection of a rotation actuator experiencing a further reduction in resistance to rotation (e.g. via another significant change in current, power, pressure, and/or voltage being needed for rotation of the chamber, etc.), the burner(s) can be adjusted for operating in a third cycle of operation. For example, this adjustment could result in moving the flame(s) from near the back of the chamber to closer to the front of the chamber, moving the flame(s) away from the metal material, shortening a flame closer to the metal material and elongating a flame positioned farther away from the metal material in the chamber, and/or any combination of these movements until the cycle is complete and the metal material is melted and or heated to its desired temperature. Heat energy can continue to enter the furnace via the flame(s) but the flame position adjustment and/or number of flames being output can permit the distribution of the heat and the flame positioning to reduce oxidation of the liquid aluminum or other metal charge material. In embodiments that utilize flame movement, the flame movement can be mechanical or valve operated with movement in any desired direction depending on the burner position for each burner and the detected state or position of the metal material being melted as noted above.

The detection of a change in the state of the metal material to be melted or being melted can include utilization of a detection and/or measurement for a resistance to rotation of the chamber in which the metal material is positioned during the heating of the metal material. This resistance to rotation can be considered as friction between the furnace chamber to metal material interface (e.g. a furnace drum to metal material interface, etc.) for a rotary furnace. Friction that can result in resistance to rotation can include static friction and kinetic friction components. The static friction component is an overall resistance to movement and the kinetic friction component can be sliding friction, rolling friction and/or viscosity of the material to be melted as the material within the chamber is affected by rotation of the furnace chamber in which that material is positioned. The static friction coefficient is typically greater than the kinetic friction coefficient applicable to such environments. An average friction value that includes the static and the kinetic friction applied by the metal material to the chamber during rotation of the chamber can be higher when the metal material is solid as compared to when it is liquid. The higher friction that is present when the metal material is solid can result in a higher angular force (e.g. torque, power, hydraulic pressure, etc.) needed to drive rotation of the chamber while the metal material is solid as compared to when it is liquid or at least partially molten. As the metal material melts, the overall friction applied by the metal material decreases, which can reduce the angular force needed for driving rotation of the chamber at the same rotational speed as was needed at the time the metal material was entirely solid or mostly solid (e.g. at least 60% by mass of the material is solid, at least 60%-80% by mass of material is solid, etc.). For instance, as the metal material melts, the static friction can be reduced and the kinetic friction that is present can also be reduced. This reduction in friction can reduce the overall friction to rotation, or resistance to rotation, that is applied by the metal material during rotation of the chamber of the furnace, which reduces the overall resistance to rotation of the chamber. This reduction in the overall resistance to rotation results in there being a smaller angular force needed for driving rotation of the chamber at the same rotational speed as was needed at the time the metal material was solid or mostly solid. This reduction in angular force that is needed for rotation of the chamber can be measured indirectly via monitoring and/or sensing at least one operational parameter related to the angular force needed for rotation such as, for example, the voltage needed by a motor to drive rotation of the chamber at a pre-selected rotational speed, the current needed by the motor to drive rotation of the chamber at a pre-selected rotational speed, the hydraulic pressure needed to drive rotation of the chamber at a pre-selected rotational speed, the power needed to drive rotation of the chamber at a pre-selected rotational speed, etc.

The static friction component of the resistance to rotation may not be a constant effect. However, the presence of static friction can be taking place between times where rotation of the chamber may cause the metal material therein to slide or roll within the chamber. An average resistance to rotation can be applied to help address such a changing occurrence of static friction and how static and kinetic friction may apply to rotation of the chamber to account for the non-constant aspect of the static friction.

Burners can operate for heating and melting of metal material within a pre-selected range of equivalence ratios. The equivalence ratio utilized can also change over time as the melting is performed to account for various factors (e.g. temperature, melted state of the metal material, volatiles present in the charge material, etc.). The equivalence ratio settings utilized for burners can also be different for different burners to account for where the burners are located relative to the material to be melted.

For instance, the equivalence ratio for burner(s) and/or burner element(s) located closer to the metal material to be melted in a chamber, or bath, can range from 0.5 to 5, 0.95 to 5 or 1 to 3.75 in different embodiments, for example. At the beginning of a melt operation (e.g. at an initial phase in which the metal material is solid state), a higher equivalence ratio may be utilized (e.g. an equivalence ratio of 5, 3.75, or other value at a higher end of a pre-selected operational range of equivalence ratios). At the end of a melt operation in which the metal material is liquified, a lower equivalence ratio may be utilized (e.g. an equivalence ratio of 0.5, 0.95, 1.0, or other value at a lower end of a pre-selected operational range of equivalence ratios).

For burner(s) and/or burner element(s) that are farther away from the metal material to be melted (e.g. closer to a roof of the chamber of the furnace, etc.) the equivalence ratio for burner(s) and/or burner element(s) can range from 0.1 to 1, 0.25 to 1 or 0.2 to 1 in different embodiments, for example. At the beginning of a melt operation (e.g. at an initial phase in which the metal material is solid state), a lower equivalence ratio may be utilized (e.g. an equivalence ratio of 0.1, 0.2, 0.25, 0.36, 0.4, or other value at a lower end of a pre-selected operational range of equivalence ratios). At the end of a melt operation in which the metal material is liquified, a higher equivalence ratio may be utilized (e.g. an equivalence ratio of 1, 0.9, 0.95, or other value at a higher end of a pre-selected operational range of equivalence ratios).

The burners and/or burner elements can also be operated such that the equivalence ratio of all burner(s) and/or burner elements utilized in the melting of the metal material can operate at an overall combined equivalence ratio within a pre-selected range of ratios (e.g. an overall combined equivalence ratio range of 1-1.1, 0.9-1.2, 0.95-1.15, etc.). The selected operational equivalence ratios can be selected to account for chamber and furnace configurations, fuel to be combusted, the type of metal material to be melted, and the presence of any combustible contaminants.

Burner and/or burner element firing rates can also be pre-selected to account for where the burner(s) and/or burner element(s) are located relative to the material to be melted and other design and operational objectives. For instance, for burner(s) and/or burner element(s) located closer to the metal material to be melted in a rotatable chamber, their firing rate can be within a pre-selected range of 10%-90%, 50%-90% or 70%-80% of the overall furnace combined firing rate of all burners, for example. At the beginning of a melt operation (e.g. at an initial phase in which the metal material is solid state), a higher firing rate allocation may be utilized for the closer burner(s) (e.g. firing rate allocation of 70%-80%, or 50%-90%, or other value at a higher end of a pre-selected operational range of firing rate allocations). At the end of a melt operation in which the metal material is liquified, a lower firing rate allocation may be utilized (e.g. a firing rate of 20%-30%, 10%-50%, or other value at a lower end of a pre-selected operational range of firing rates).

For burner(s) and/or burner element(s) that are farther away from the metal material to be melted (e.g. closer to a roof or ceiling of the chamber, etc.) the range of firing rate allocations for such burner(s) and/or burner element(s) can range from 10% to 90%, 20%-80%, or other pre-selected firing rate allocation range of the overall furnace firing rate in different embodiments, for example. At the beginning of a melt operation (e.g. at an initial phase in which the metal material is solid state), a lower firing rate allocation may be utilized for the farther away burner(s) (e.g. a firing rate allocation of 20%-30%, a firing rate of 10%-50%, or other value at a lower end of a pre-selected operational range of firing rate allocations). At the end of a melt operation in which the metal material is liquified, a higher firing rate allocation may be utilized (e.g. firing rate of 70%-80%, 50%-90%, or other value at a higher end of a pre-selected operational range of firing allocation ratios).

At or near the end of a melting operation in which the metal material is liquified, the firing rate may decrease further as the end of the melt operation approaches. And the firing of the burners can also, in some embodiments, be ceased after a full melt has occurred in some embodiments.

Embodiments can be configured for utilization in conjunction with any number of different arrangements of burners or burner elements. For example, embodiments can be configured so that an array of burners in the furnace that are controlled include a number of different spaced apart burners that are positioned on a furnace door or other suitable location. As another example, embodiments can be configured so that a single burner or a pair of burners is utilized on a door of the furnace. As yet another example, embodiments can be configured so that an array of burners in the furnace that are controlled include a number of different spaced apart burners in which one or more of the burners are positioned on a door of the furnace to output at least one flame into the chamber of the furnace and at least one other burner is positioned in another location for outputting at least one flame into the rotatable chamber of the furnace.

Embodiments can be configured to utilize different types of material state change detection mechanisms or utilize different detection schemes for determining a material state of the metal material for triggering an adjustment in operation of one or more burners. Some embodiments can utilize one or more sensors that can facilitate a detection of one or more parameters related to the material state change of the metal material. For example, some embodiments can be configured to detect a material state change based on a detected change in motor current, hydraulic pressure, hydraulic motor current, and/or other parameter related to the power required to rotate the chamber of a rotary furnace. A change that exceeds a pre-selected threshold, for example, can be detected to identify a sufficient change in the state of the metal material to indicate that the burner operation should be adjusted to avoid overheating of the metal material and possible burning of the metal material. Such a detection can be provided via at least one current sensor, at least one voltage sensor, at least one power sensor, at least one force sensor, and/or at least one pressure sensor, for example.

In other embodiments, one or more sensors can detect other parameters indicative of a material state change of the metal material such as, for example, a significant change in furnace vibrations, ultrasound detection of the surface of the metal material being melted, pressure measurements, use of a laser or other optical sensor to detect surface distributions, visible and/or infra-red camera(s) to optically determine surfaces of the metal material in the furnace chamber, and/or a combination of these sensor approaches, etc.

Data from one or more sensors and/or detectors can be provided to a controller that can evaluate the sensor data based on a pre-defined evaluation scheme for use in detection of a material state change. A controller or other type of computer device can be utilized to implement this pre-defined evaluation scheme. For example, the pre-defined evaluation scheme can be performed via a computer device that utilizes a static or machine learning model. A machine learning model can consist of but not limited to a convolutional neural network (CNN) and\or other neural network(s) for image processing and/or classification. A machine learning model can also consist of but not limited to other statistical methods such as clustering and/or regression for data processing and prediction. In response to a detected material state change that is based on the sensor data and/or model, the controller can adjust operation of the burner(s).

In some embodiments, the detecting of the material change in state of the metal material can utilize at least one sensor or detector for detecting an operating current for a motor driving rotation of the chamber, at least one sensor or detector for detecting an operating power or voltage for a motor driving rotation of the chamber, at least one sensor or detector for detecting an operating pressure for at least one actuator (e.g. hydraulic driven motor or actuator) driving rotation of the chamber, at least one sensor or detector for detecting an a rotational speed of the chamber, at least one sensor or detector for detecting vibrations of the chamber of the furnace being rotated and/or one or more sensors that detect a reduced angular force needed to rotate a chamber retaining the metal material to be melted. Embodiments can also utilize one or more temperature sensors, at least one flow sensor, at least one rotational sensor, at least one pressure sensor, at least one composition sensor, at least one vibrational sensor, laser sensor(s), ultrasonic sensor(s), at last one camera or other type of sensor for collecting one or more images in visible and/or infra-red light, temperature changes of the furnace or of the metal via one or more temperature sensors, flue gas temperature via one or more temperature sensors, composition changes via one or more compositional detection sensors or composition analyzers, and/or changes in resistance to rotation of the chamber of the furnace, or combinations of such sensors or detectors. The material state change determinations can be based on either absolute changes, changes in the trends of the measurement data provided via the sensor(s) and/or detector(s), or changes in imagery data or other data.

In a first aspect, a process for melting metal material can be provided. Embodiments of the process can include directing at least one flame to metal material in a rotating chamber such that the at least one flame impinges the metal material or is within a pre-selected distance that is no greater than 1 meter from the metal material while an entirety of the metal material is in a solid state. Embodiments of the process can also include adjusting the at least one flame to move the at least one flame away from the metal material or deactivating an output of the at least one flame in response to detecting that the metal material has melted such that the metal material is at least in a partially liquid state.

In some embodiments, a controller having a processor connected to a non-transitory computer readable medium (e.g. non-transitory memory, flash memory, etc.) can be utilized to receive sensor data and determine a change in the metal material to at least a partially liquid state of the metal material to detect that the metal material has melted. In some embodiments, such a detection can be based on sensor data. In other embodiments, such a detection can be from utilization of a model defined in the memory of the controller that is run by the processor of the controller that results in the controller predicting when the metal material will be in at least a partially liquid state to detect the melting of the metal material. Such a prediction can be based on utilization of sensor data utilized in the running of the defined model.

In a second aspect the adjusting of the at least one flame to move the at least one flame away from the metal material can include (i) shortening of the at least one flame to avoid burning of the metal material, (ii) adjusting a firing rate of the at least one burner that outputs the at least one flame, and/or (iii) adjusting operation of the at least one burner so that the at least one flame extends horizontally relative to an upper surface of the metal material and above the upper surface. For example, in some embodiments, the adjusting of the at least one flame to move the at least one flame away from the metal material can include adjusting operation of at least one burner that outputs the at least one flame so that the at least one flame is shorter.

In a third aspect, the adjusting of the at least one flame to move the at least one flame away from the metal material can include adjusting operation of at least one burner that outputs the at least one flame so that the at least one flame extends at an angle of inclination away from an upper surface of the metal material.

In a fourth aspect, the process can also include detecting that the metal material has melted such that the metal material is at least in a partially liquid state based on a detection that an amount of force, pressure, power, voltage, and/or current used to rotate the chamber has decreased to a pre-selected threshold value or decreased by a pre-selected threshold value. For instance, in some embodiments the detecting that the metal material has melted such that the metal material is at least in a partially liquid state can be based on a detection that an amount of hydraulic pressure utilized to rotate the chamber has decreased to a pre-selected threshold value or decreased by a pre-selected threshold value.

In a fifth aspect, the process can include detecting that the metal material has melted such that the metal material is entirely in the liquid state. The detecting that the metal material has melted such that the metal material is entirely in the liquid state can include a controller receiving data from at least one sensor positioned to detect or monitor at least one parameter associated with an amount of force or power used for rotation of the rotatable body.

In a sixth aspect, the process can include detecting that the metal material has melted such that the metal material is at least in the partially liquid state. The detecting that the metal material has melted such that the metal material is at least in the partially liquid state can include a controller receiving data from at least one sensor positioned to detect or monitor at least one parameter associated with a surface of the metal material in the rotating chamber. Examples of sensor data can include sensor data from a laser, a camera, and/or an ultrasonic sensor.

In a seventh aspect, the process can include detecting that the metal material has melted such that the metal material is at least in the partially liquid state. The detecting that the metal material has melted such that the metal material is at least in the partially liquid state can include a controller running a model defined in non-transitory memory of the controller to predict that the metal material is at least in the partially liquid state based on sensor data received by the controller. In some embodiments, the sensor data received by the controller can include sensor data from a camera, a laser, an ultrasonic sensor, a current sensor, a voltage sensor, a motor power sensor, a rotational force sensor, an ultrasound sensor, and/or an imaging sensor.

In an eighth aspect, the adjusting of the at least one flame to move the at least one flame away from the metal material can include adjusting operation of a lower burner mounted to a door of a rotatable body that defines the chamber.

In a ninth aspect, embodiments of the process can also include adjusting operation of an upper burner mounted to the door to account for the adjusting of the operation of a lower burner. In such embodiments, the upper burner can be above the lower burner.

In a tenth aspect, the process of the first aspect can include one or more features of the second aspect, third aspect, fourth aspect, fifth aspect, sixth aspect, seventh aspect, eighth aspect and/or ninth aspect. Embodiments can also utilize other features or elements. Examples of such additional features or elements can be appreciated from the discussion of exemplary embodiments provided herein, for instance.

In an eleventh aspect, an apparatus for melting metal material is provided. Embodiments of the apparatus for melting material can include a rotatable body having a chamber sized to receive metal material for melting of the metal material and at least one burner positionable adjacent to the chamber to output at least one flame for melting of the metal material that is positionable in the chamber. Embodiments of the apparatus can also include a controller having a processor connected to a non-transitory computer readable medium. The controller can be communicatively connectable to at least one sensor and the at least one burner. The controller can be configured to control operation of the at least one burner so that the least one flame impinges an upper surface of the metal material or is within a pre-selected distance that is no greater than 1 meter from the metal material while an entirety of the metal material is in a solid state. The controller can also be configured to determine that the metal material has melted such that the metal material is at least in a partially liquid state liquid state based on sensor data received from the at least one sensor, and, in response to determining that the metal material is at least partially in the liquid state, control operation of the at least one burner to adjust the at least one flame to move the at least one flame away from the metal material.

In some embodiments, he at least one sensor can include one or more sensors positioned to monitor or measure at least one parameter indicative of a melted state of the metal material. The controller can include a model defined in its non-transitory computer readable memory to utilize sensor data from the sensor(s) to determine that the metal material is at least partially melted (e.g. is significantly melted, is mostly melted, is entirely melted, etc.). In some embodiments, the controller can make such a determination via running the model to predict when the metal material is at least partially melted, for example. In other embodiments, the controller can be configured to utilize the sensor data to detect the state of the metal material based on the sensor data.

In a twelfth aspect, the controller can be configured to control operation of the at least one burner to adjust the at least one flame to move the at least one flame away from the metal material via (i) shortening of the at least one flame to avoid burning of the metal material, (ii) adjusting a firing rate of the at least one burner, (iii) ceasing an outputting of the at least one flame via the at least one burner, (iv) adjusting operation of the at least one burner so that the at least one flame is positioned at a greater distance from the metal material within the chamber, and/or (v) adjusting operation of at least one burner so that the at least one flame extends at an angle of inclination away from the metal material.

For example, the controller can be configured to control operation of the at least one burner to adjust the at least one flame to move the at least one flame away from the metal material via adjusting operation of at least one burner so that the at least one flame extends at an angle of inclination away from the metal material. As another example, the controller can be configured to control operation of the at least one burner to adjust the at least one flame to move the at least one flame away from the metal material via adjusting operation of at least one burner so that the at least one flame is shorted to be positioned further away from the metal material and above the upper surface.

In a thirteenth aspect, the at least one sensor can be positioned and configured to provide sensor data to the controller to monitor an amount of power, force, hydraulic pressure, voltage, or current used to rotate the rotatable body and/or monitor a surface of the metal material in the rotatable chamber. For instance, in some embodiments, the sensor(s) can be positioned and configured to provide sensor data to the controller and the sensor(s) can include a current sensor, a voltage sensor, a motor power sensor, a rotational force sensor, an ultrasound sensor, an imaging sensor, a camera, a laser, and/or an ultrasonic sensor.

In a fourteenth aspect, the apparatus can also include at least one actuator positioned to drive rotation of the rotatable body at a pre-selected rotational speed and/or a vessel positionable adjacent a moveable door connected to the rotatable body.

In other embodiments, the apparatus can also include a tilt mechanism for tilting of the rotatable body for pouring melted metal material into a vessel. In other embodiments, the rotatable body can include a moveable plug that can be adjusted to open a drain or outlet for passing the melted metal material out of the chamber of the rotatable body.

In a fifteenth aspect, the controller can have a model defined in the non-transitory computer readable medium of the controller to predict that the metal material is at least in the partially liquid state based on the sensor data that is receivable by the controller. The controller can determine that the metal material is at least partially in the liquid state based on running the model to predict that the metal material is at least in the partially liquid state. Sensor data can be utilized in the running of the model to make such a determination.

In a sixteenth aspect, embodiments of the apparatus can be configured to implement an embodiment of the process for melting metal material.

In a seventeenth aspect, the apparatus of the eleventh aspect can include one or more features or elements of the twelfth aspect, thirteenth aspect, fourteenth aspect, fifteenth aspect, and/or sixteenth aspect. Embodiments may also utilize other features or elements. Examples of additional features or elements can be appreciated from the exemplary embodiments of the apparatus discussed herein, for example.

In an eighteenth aspect, a control system is provided. The control system can be a control system that can help control a process for melting metal material. In some embodiments, the control system can include a controller having a processor connected to a non-transitory computer readable medium. The controller can be communicatively connectable to the at least one sensor and at least one burner positioned to output at least one flame to melt metal material within a rotatable chamber. The controller can be configured to control operation of the at least one burner so that the least one flame impinges an upper surface of the metal material or is within 1 meter of the upper surface of the metal material while an entirety of the metal material is in a solid state. The controller can also be configured to determine that the metal material has melted such that the metal material is at least in a partially liquid state based on sensor data received from the at least one sensor, and, in response to determining that the metal material is in the at least partially liquid state, control operation of the at least one burner to adjust the at least one flame to move the at least one flame away from the metal material or cease outputting of the at least one flame.

In a nineteenth aspect, the control system can also include a control evaluation device communicatively connectable to the controller. The control evaluation device can have a processor connected to a non-transitory computer readable medium. The control evaluation device can be configured to evaluate operational data from melting of metal material that occurred in prior melting operations based on at least one pre-defined control evaluation scheme to identify one or more control parameter adjustments and communicate data to adjust the one or more control parameters to be utilized by the controller based on results from implementation of the at least one pre-defined control evaluation scheme indicating that the one or more control parameter adjustments will improve yield, increase production, and/or reduce energy consumption for melting of the metal material.

In some embodiments, the control evaluation device can be or include a remote computer device that can be communicatively connected to the controller via a network (e.g. the internet, a wide area network, an enterprise network, etc.). In other embodiments, the control evaluation device can be communicatively connected to the controller via a more proximate communicative connection (e.g. near field communication connection, local area network connection, etc.). In yet other embodiments, the control evaluation device can be integrated into the controller.

In a twentieth aspect, embodiments of the control system can include one or more features of the nineteenth aspect as well as other elements or features. For example, the control system can include one or more sensors and/or be configured to implement an embodiment of the process for melting metal material or implement at least one step of such a process. Embodiments of the control system can also be integrated into an embodiment of the apparatus for melting metal material. It should therefore be understood that other embodiments of the control system can include other features or elements, examples of which can be understood from the exemplary embodiments discussed herein.

Other details, objectives, and advantages of an apparatus to melt metal, a process for melting metal, an apparatus to control the flame(s) used for melting of metal, and processes for controlling at least one flame for the melting of metal, and methods of making and using the same will become apparent as the following description of certain exemplary embodiments thereof proceeds.

### BRIEF DESCRIPTION OF THE DRAWINGS

Exemplary embodiments of an apparatus to melt metal, a process for melting metal, an apparatus to control the flame(s) used for melting of metal, and processes for controlling at least one burner for the melting of metal, and methods of making and using the same are shown in the drawings included herewith. It should be understood that like reference characters used in the drawings may identify like components.

FIG. 1 (which can also be referred to as FIG. 1) is a schematic diagram of a first exemplary embodiment of an apparatus 1 for melting of metal material. The embodiment of the apparatus 1 can include an exemplary embodiment of a control system 21 for controlling at least one flame utilized to melt the metal material.

FIG. 2 (which can also be referred to as FIG. 2) is a schematic flow chart illustrating a first exemplary embodiment of a process for melting metal material utilizing the first exemplary embodiment of the apparatus 1.

FIG. 3 (which can also be referred to as FIG. 3) is a schematic flow chart illustrating a second exemplary embodiment of a process for melting metal material utilizing the first exemplary embodiment of the apparatus 1.

FIG. 4 (which can also be referred to as FIG. 4) is a schematic flow chart illustrating a third exemplary embodiment of a process for melting metal material utilizing the first exemplary embodiment of the apparatus 1.

FIG. 5 (which can also be referred to as FIG. 5) is a schematic flow chart illustrating a fourth exemplary embodiment of a process for melting metal material utilizing the first exemplary embodiment of the apparatus 1.

FIG. 6 (which can also be referred to as FIG. 6) is a graph illustrating a monitored parameter that is associated with a change in the state of metal material being melted to illustrate an example of how a change in the monitored parameter can indicate that an adjustment in the operation of the burner(s) or burner elements can be provided to account for the metal material being sufficiently melted so that burning of the metal material can be avoided. In some embodiments, the parameter being monitored can be motor current, motor voltage, hydraulic pressure, or other parameter related to the power required to rotate the chamber 3c via an actuator 5 (e.g. motor, hydraulic actuator, etc.) that is connected to the chamber 3c to drive rotation of the chamber while metal material (MM) within the chamber is being melted.

FIG. 7 (which can also be referred to as FIG. 7) is a flow chart of an exemplary embodiment of a process for melting metal material MM that can be utilize by an embodiment of the apparatus 1 for melting of metal material.

FIG. 8 (which can also be referred to as FIG. 8) is a graph illustrating exemplary melting condition parameters that can be evaluated for updating control parameter settings of a controller CTRL for control of operations of an apparatus 1 for melting of metal.

### DETAILED DESCRIPTION

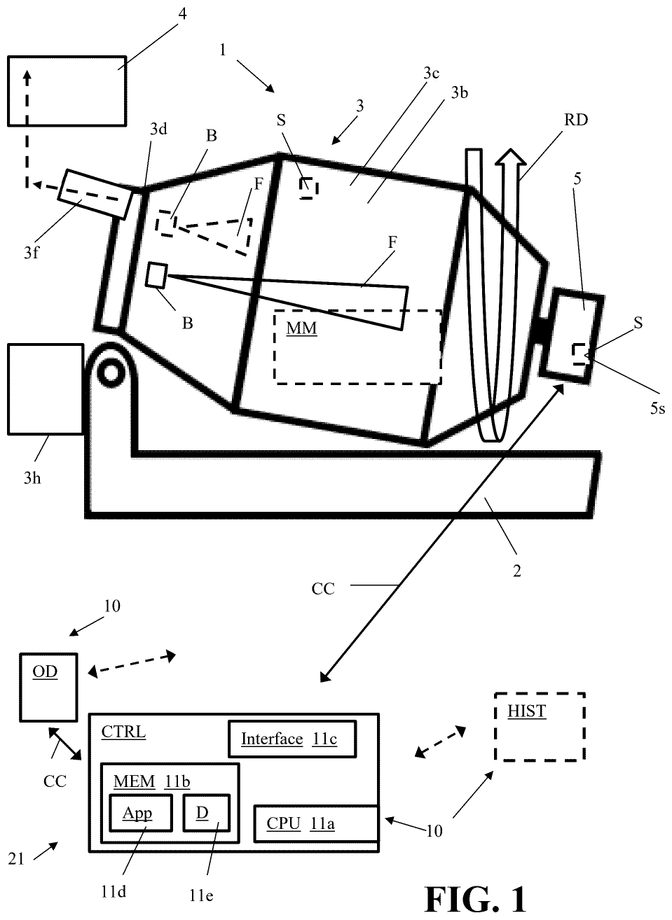

Referring to FIGS. 1-7, an apparatus 1 for melting of metal material can be configured as a rotary furnace 3 or other type of suitable furnace. The apparatus 1 can include a housing that has a base 2 that can support a rotatable chamber 3c. The rotatable chamber 3c can be defined within a rotatable body 3b (e.g. a rotatable drum, etc.) that is supported on the base 2 and is coupled to an actuator 5 that is configured to drive rotation of the chamber 3c. The chamber 3c can be sized and configured to receive metal material therein for melting of the metal material within the chamber 3c. The chamber 3c can include a bath or other defined structure within the chamber for receipt of the metal material to be melted within the chamber 3c.

The rotatable body 3b that defines the chamber 3c can also have a door 3d that can be moveably connected to the body so the door 3d can be opened to feed metal material into the chamber 3c, closed for melting of the metal material, and opened for pouring the melted metal material out of the chamber 3c and into a vessel 3h positioned below the door 3d and adjacent to the door 3d. In some embodiments, the rotatable body 3b can be pivotally connected to the base 2 or other support to facilitate tilting motion of the rotatable body to facilitate pouring of the melted metal into the vessel 3h. One or more actuators (e.g. hydraulic springs, hydraulic pistons, other type of actuator, etc.) can be coupled to the body 3b to facilitate such tilting for the pour.

In other embodiments, the rotatable body 3b may not be tiltable and the removal of melted metal from the rotatable body 3b can be provided via other mechanisms (e.g. a drain that can have a removable plug or a plug that is adjustable between closed and opened positions, etc.) so that the melted metal can be passed out of the rotatable body 3b or otherwise removed from the rotatable body 3b without titling of the rotatable body 3b.

One or more burners B can be positioned to output at least one flame F into the chamber 3c for heating metal material MM within the chamber 3c to melt the metal material MM. For example, one or more burners B can be positioned above the bath of the chamber 3c adjacent to the door 3d or on the door 3d for outputting at least one flame F in the atmosphere within the chamber 3c above the surface of the metal material MM that is to be melted. The atmosphere can be the enclosed atmosphere that is enclosed by the walls and ceiling of the rotatable body 3b that defines the chamber 3c.

The apparatus can also include one or more flues 3f that can be positioned so that flue gas formed via combustion of the fuel to form the flame(s) F can be passed out of the chamber 3c for being processed and/or emitted to the atmosphere. In some embodiments, at least one flue 3f can be positioned adjacent a door 3d to facilitate a flow of hot flue gas passing out of the chamber 3c, through a flue gas conduit defined by the flue 3f, to a vent 4 for venting of the flue gas. Prior to venting, the flue gas can be fed to one or more heat exchangers for use of the heat of the flue gas before the flue gas is emitted to the atmosphere. The flue gas output via the flue(s) 3f can also be treated by one or more flue gas treatment devices for removal of pollutant materials (e.g. particulates, nitrous oxides, etc.).

Each burner B can be mounted to the door 3d or other suitable location of the body 3b that defines the chamber 3c. Each burner B can be configured as an oxy-fuel burner, a transient burner with multiple burner elements, or other type of suitable burner that can output a flow of fuel that can be combusted in the presence of an oxidant (e.g. air, oxygen enriched air, etc.). The oxidant can also be output via the burner with the fuel in a pre-mixed or partial mixed flow of the fuel and oxidant, for example.

There can also be at least one sensor S positioned for detecting data related to the melting of metal material MM in the chamber 3c. Each sensor S can be positioned on, within or adjacent a portion of the body 3b or door 3d. Each sensor S can be communicatively connected to a controller CTRL for providing sensor data to the controller CTRL. One or more sensors S may also, or alternatively, be positioned for monitoring utilization of at least one parameter of the actuator 5 used to drive rotation of the chamber 3c via rotating of the rotatable body 3b. The sensor(s) S can be an actuator sensor 5s positioned to monitor the utilization of electrical current, voltage, power, hydraulic pressure, torque applied by the actuator, or a force applied by the actuator to drive rotation of the rotatable body 3b, or other actuator parameter related to the operation of the actuator 5 to drive rotation of the rotatable body 3b.

As may best be appreciated from FIG. 1, a controller CTRL can be a computer device 10 that includes a processor CPU communicatively connected to a non-transitory memory MEM and at least one transceiver (Interface). The memory 11b can store code thereon that can be executed by the processor 11a. The memory 11b can also store at least one application App and/or at least one data store D thereon. The application 11d can be run by the processor 11a and the code of the application 11d run by the processor 11a can utilize data from one or more of the data stores D. The data stores 11e can include files, databases, or other types of data stores.

The controller CTRL can be communicatively connected to the sensor(s) S as well as at least one valve for providing of fuel and/or oxidant to the burner(s) B via communicative connections CC between the controller CTRL and these process control elements. Each valve can be adjustable to control a flow rate of fuel and/or oxidant to one or more burners B. The controller CTRL can also be communicatively connectable to the burner(s) B for adjustment of one or more valves of the burner(s) and/or other elements of the burner(s) B for controlling operation of the burner(s) B.

The controller CTRL can also be communicatively connected to one or more computer devices 10 (e.g. one or more input devices, one or more output devices, or one or more other types of computer devices 10, etc.). In some embodiments, the controller CTRL can be configured as an operator device OD that can provide a graphical user interface (GUI) to a user to facilitate receipt of input from the operator and also provide output to the operator to provide notifications, warnings, or other data about the operation of the apparatus 1 to the operator. In other embodiments, the controller CTRL can be communicatively connected to the operator device OD (which can be a type of computer device 10) to provide data to the operator device OD for generation of a GUI to the operator. The GUI or data provided to generate the GUI can include data that can provide output to an operator to provide notifications related to operations of the apparatus 1 and/or burners B, request confirmation for certain processing adjustments to be provided by operator input that responds to the notification(s) and/or facilitate the providing of output to an operator and/or receipt of input from the operator for use in controlling or adjusting operations of the apparatus 1 and/or the burner(s) B.

As discussed further herein, the controller CTRL can also provide data collected via sensor(s) S and other elements to a control evaluation device HIST via a communicative connection CC between the controller CTRL and the control evaluation device HIST. The control evaluation device HIST can be a computer device 10 that includes a processor 11a communicatively connected to a non-transitory memory 11b and at least one transceiver 11c. The memory 11b can store code thereon that can be executed by the processor 11a. The memory 11b can also store at least one application App and/or at least one data store D thereon. The application can be run by the processor and the code run by the processor can utilize data from one or more of the data stores DS. The data stores can include files, databases, or other types of data stores. The control evaluation device HIST can also be communicatively connected to one or more computer devices 10 (e.g. one or more input devices, one or more output devices, or one or more other types of computer devices 10, etc.).

The control evaluation device HIST can have at least one pre-defined control evaluation scheme defined by code that can be run by its processor to evaluate stored data received from the controller CTRL and/or other control system elements (e.g. sensors S, actuator 5, etc.) to evaluate that data for use in evaluating whether one or more control parameters of the controller CTRL should be adjusted or updated.

As may best be appreciated from FIGS. 1-5, the controller CTRL and sensor(s) S can be configured to control the formation and adjustment of flame(s) F output via burner(s) B during the melting of metal material from an entirely solid state (solid) to an entirely liquid state (liquid). When the metal material is in an entirely solid state, it can be in a pile in the chamber 3c or a bath defined in the chamber 3c. When the metal material is entirely solid, it can be a new batch of metal material to be melted that is entirely solid. In the event a small portion of liquid metal from a prior batch remains in the chamber 3c, the metal material may still be considered entirely solid because the new batch added for melting is entirely solid and makes up a majority of the metal to be melted in the bath of the chamber. The small portion of liquid metal from a prior batch that may remain in such situations can be dependent on the furnace and burner configuration that may be utilized. In some embodiments, this remaining small portion of molten material (if present) can be greater than 0 weight percent (wt %) of the metal material in the bath of the chamber to less than 40 wt % of the metal material in the bath of the chamber 3c, between 0 wt % and 30 wt % of the metal material in the bath of the chamber 3c, between 0 wt % and 20 wt % of the metal material in the bath of the chamber 3c, or between 0 wt % and 10 wt % of the metal material in the bath of the chamber.

When the metal material MM is in a solid state (solid), which can be an entirely solid state or a mostly solid state, rotation of the chamber 3c via rotation of the body 3b defining the chamber 3c driven by the actuator(s) 5 can incur significant resistance to the rotation of the body 3b having the chamber 3c. This resistance to rotation can be considered friction induced via static friction and kinetic friction. This friction can be applied via the mass of the metal material rolling or sliding (causing significant vibrations), and other forces applied by the metal material moving as a consequence of the rotation of the chamber 3c in which the metal material MM is positioned.

For example, the resistance to the rotation of the body 3b driven by the actuator(s) 5 can be considered as friction between the furnace chamber 3c to metal material interface (e.g. sidewall(s) of the body 3b defining the chamber 3c to metal material interface, etc.). Friction that can result in resistance to rotation can include static friction and kinetic friction components. The static friction component can be an overall resistance to movement and the kinetic friction component can be sliding friction, rolling friction and/or viscosity of the material to be melted as the material within the chamber is affected by rotation of the furnace chamber in which that material is positioned. The static friction coefficient is typically greater than the kinetic friction coefficient applicable to such environments.

An average friction value that includes the static and the kinetic friction applied by the metal material MM to the chamber 3c during rotation of the chamber 3c can be higher when the metal material MM is solid or mostly solid as compared to when it is liquid. The higher friction that is present when the metal material MM is solid can result in a higher angular force (e.g. torque, power, hydraulic pressure, etc.) needed to drive rotation of the chamber 3c while the metal material MM is solid as compared to when the metal material MM is liquid or at least partially molten. As the metal material MM melts, the overall friction applied by the metal material MM can decrease, which can reduce the angular force needed for driving rotation of the chamber 3c at the same rotational speed as was needed at the time the metal material MM was entirely solid or mostly solid (e.g. at least 60% by mass of the material is solid, at least 60%-80% of the mass of material is solid, etc.).

For instance, as the metal material MM melts, the static friction can be reduced and the kinetic friction that is present can also be reduced. This reduction in friction can reduce the overall friction to rotation, or resistance to rotation that is applied by the metal material MM during rotation of the chamber 3c of the furnace that is driven by the actuator(s) 5. This can reduce the overall resistance to rotation of the chamber. This reduction in the overall resistance to rotation results in there being a smaller angular force needed for driving rotation of the chamber at the same rotational speed as was needed at the time the metal material was solid or mostly solid. This reduction in angular force that is needed for rotation of the chamber 3c can be measured indirectly via at least one sensor S communicatively connected to the controller CTRL monitoring and/or sensing at least one operational parameter related to the angular force needed for rotation such as, for example, the voltage needed by a motor of the actuator(s) 5 to drive rotation of the chamber 3c at a pre-selected rotational speed, the current needed by the motor of the actuator(s) 5 to drive rotation of the chamber 3c at a pre-selected rotational speed, the hydraulic pressure of the actuator(s) 5 needed to drive rotation of the chamber 3c at a pre-selected rotational speed, the power needed by the actuator(s) 5 to drive rotation of the chamber 3c at a pre-selected rotational speed, etc.

The static friction component of the resistance to rotation may not be a constant effect. However, the presence of static friction can be taking place between times where rotation of the chamber 3c may cause the metal material MM therein to slide or roll within the chamber 3c. An average resistance to rotation can be utilized by the controller CTRL to help address such a changing occurrence of static friction and how static and kinetic friction may apply to rotation of the chamber 3c to account for the non-constant aspect of the static friction and sensor data related to the same that the controller may receive from one or more sensors S.

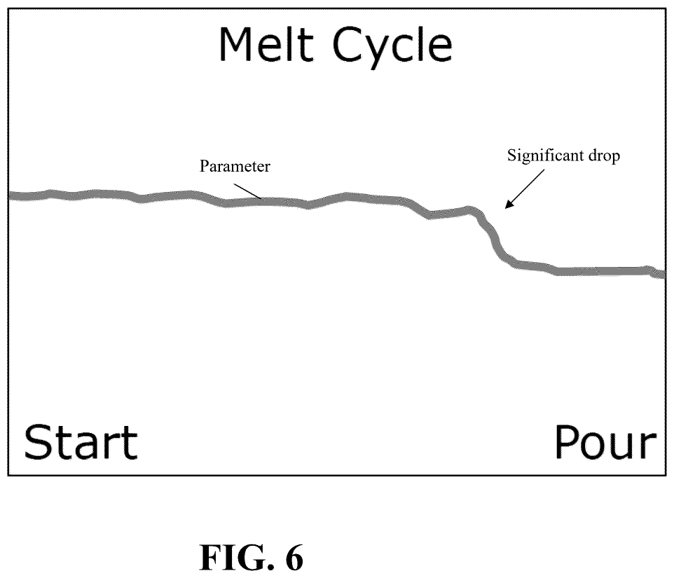

When the metal material MM is an entirely liquid state, the resistance to rotation of the metal material can change significantly. This can be determined based on the reception of sensor data from the sensor(s) S and evaluation of that data performed by the controller CTRL. For instance, a reduction in at least one parameter that is significant can be identified by the controller to indicate that the metal material has changed in state from solid or mostly solid to liquid or mostly liquid. FIG. 6 illustrates a graph of received sensor data that includes a significant drop in a parameter that can be an indirect measure or a direct measure of power or force needed for rotation of the chamber 3c at a pre-selected rotational speed of the chamber 3c. A significant change that exceeds a pre-selected threshold in the monitored parameter(s) can be utilized to trigger detection of the change in state from solid to liquid. In response to such a detection, the controller CTRL can communicate with the burner(s) B and/or other elements to adjust operation of the burner(s) B.

For instance, during heating of the metal material MM, the burner(s) B can be adjusted in operation to adjust the flame(s) F that are output from the burner(s) B. The flame F adjustment can adjust how long a flame is, where the flame is directed, a firing rate for the burner(s) B and/or a combination of these parameters. The flame F adjustment can be provided via controlling how a flow of fuel and/or a flow of oxidant is output from the burner(s) and/or controlling an orientation of the burner (e.g. via mechanical motion of the burner to alter its orientation via pivoting, rotation, etc.).

For example, the burner(s) B can be operated to adjust their operational state from a first mode of operation to a second mode of operation in which the flame(s) F output from the burner(s) B are adjusted from the first mode to the second mode to move the flame(s) away from the metal material MM to be melted in conjunction with the adjustment from the first mode of operation to the second mode of operation. In other embodiments, the adjustments can include other adjustments (e.g. from a second mode of operation to a third mode of operation). For example, the burner(s) B can be adjusted from a first mode of operation to a second mode of operation, from the second mode of operation to a third mode of operation, and from the third mode of operation to a fourth mode of operation. Each adjustment in the mode of operation can be performed to redirect the flame(s) F output from the burner(s) B to move the flame(s) away from more liquified metal to help limit any type of metal burning that could occur via the melting process while also improving the effective utilization of the flame(s) to heat the metal material for melting of that material to an entirely liquid state.

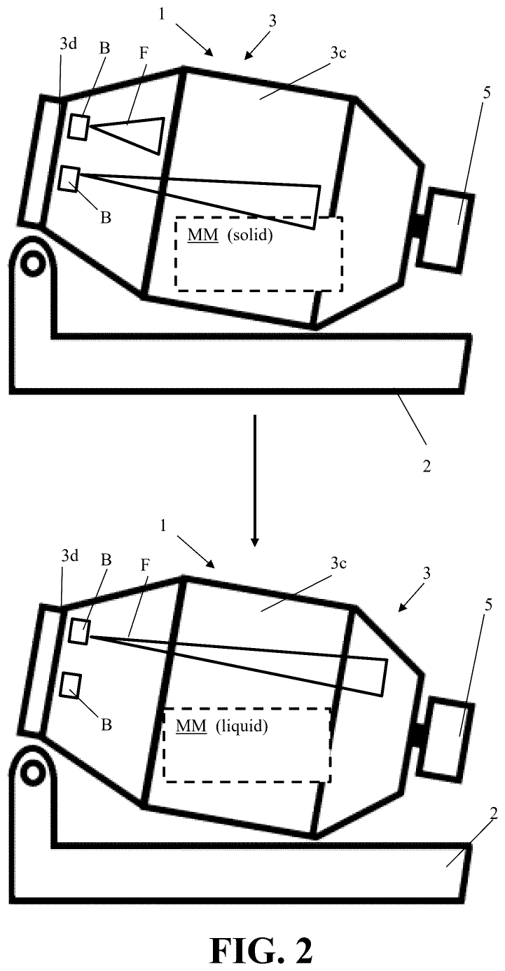

For example, as may be seen from FIG. 2-5, one or more flames F that can be output from one or more burners B can be directed to metal material in a solid state that is in the rotatable chamber 3c. The flame(s) F can be directed to the metal material so that at least one of the flames F is directed to the surface of the metal material MM or near the surface of the metal material MM in the chamber 3c. In some configurations, the distal end of each flame F can be in close proximity to the surface of the metal material MM and/or in contact with the surface of the metal material MM without risk of burning of the metal material because the metal material is in a solid state and it has a high tolerance for being heated without burning or oxidation of the metal occurring. For instance, the distal end of a flame F can be in direct contact with solid state metal material MM or can be positioned within 1 meter or 0.5 meters of the solid state metal material (e.g. 0-1 meters from the solid state metal material, between greater than 0 meters and 0.5 meters from the solid state metal material, between greater than 0 meters and 0.1 meters from the solid state metal material, etc.)

The distal end of the flame F and distance the distal end of the flame F has to the solid state metal material can also be determined based on input material. For example, this type of input material description can be saved in a historian that is accessible to a controller that controls the burner operations to control the size and direction of the flame(s) F to have the distal end of the flame(s) F at a pre-selected distance from the solid state metal material MM in the chamber 3c. The pre-selected distance can be a defined parameter or variable. This parameter can be updated based on operator input and/or an evaluation of empirical use that may occur via machine learning or other evaluation process.

A material description for the input material can be any combination of size, shape, alloy, type, impurities, etc., or any other value that can describe the metal material. For example, the distance between the distal end of a flame F and the solid state material MM can be adjusted so that for larger sized pieces of material there is a smaller distance between the distal end of the flame F and material as compared to smaller size pieces of solid material because the smaller material may have a higher probability of burning than the larger material. The larger pre-selected distance can be selected to account for such a possibility to help facilitate improved heating and melting while also avoiding the burning of the metal material.

The pre-selected distance between the distal end of the flame(s) F and the solid state metal material MM can also be based on other sensor data or other criteria (e.g. modeling output, machine learning data, etc.). For example, a detected current temperature of the material (or by proxy time in a current firing/melting mode) can be utilized to adjust the distance between the distal end of the flame(s) F and the solid state metal material. As the material approaches its melting point for the metal material MM it can be more susceptible to burning and therefore the distance between the distal end of the flame(s) F and the solid state material can be controlled so that this distance increases to greater values as the metal material melts (e.g. the distance between the distal end of the flame and the solid state metal material can be smallest when the heating of the solid metal material starts and can be increased to be a greater distance as the material heats and gets closer in temperature to its melting temperature).

As the heating progresses, the metal material will melt and begin to liquify. In this type of intermediate stage of the melting process, the metal material MM can include solid state metal material as well as liquid state metal material. The proportion of the metal material MM that is in the liquid state can increase so less material in the solid state is present until the entirety of the metal material is melted and in a liquid state.

As the metal material melts, the force needed to rotate the body 3b having the chamber 3c that retains the metal material MM therein can decrease as the liquid state metal material will exert less friction or other force(s) to resist rotation of the chamber 3c as compared to more solid state metal material MM. After the metal material MM is fully melted so that the metal material is entirely liquid (e.g. is entirety in a liquid state) or almost entirely liquid the resistant force to rotation exerted by the metal material MM in the chamber 3c will significantly decrease and, this significant reduction can be identified to trigger a change in operation of the burner(s) B to adjust how the metal material MM is heated to help avoid burning of the metal material MM.

During the melting process, at least one sensor S can be utilized to monitor the metal material MM within the chamber 3c to determine when it has begun to sufficiently melt such that the burner(s) B should be adjusted in operation to adjust a direction of the flame(s) F. For example, a sensor S can be positioned to monitor an amount of force applied by one or more actuators 5, a current or voltage utilized by a motor of the actuator(s) 5 that can drive rotation of the chamber 3c, and/or a sensor positioned to monitor the power utilized or applied by the actuator(s) 5 to rotate the chamber 3c. The sensor(s) S can include a sensor 5a of an actuator 5 that can be communicatively connected to a controller CTRL, for example.

The sensor(s) can also include other sensors S, such as, for example, a temperature sensor or other sensor S that may be positioned to monitor one or more conditions in the chamber 3c. The sensor(s) S can also include an ultrasound detector, camera, laser, ultrasonic sensor, or other type of detector that may be configured to monitor a surface or other condition of the metal material MM within the chamber 3c, for example. In some embodiments, a camera, laser, and/or ultrasonic sensor can be utilized as at least one sensor S to measure or monitor a surface of the metal material MM in the chamber 3c to detect changes in the surface of the metal material to detect at least a partially melted state of the metal material MM and/or detect a state of the metal material in which it is entirely liquid. Such a detection can be based at least one part on evaluating how the surface may change over a period of time (e.g. changes in the detected surface occur less frequently or become more uniform, surface changes are detected as being within a pre-selected change parameter, the detected surface is determined to have a profile that meets or is within a pre-selected profile, etc.). In response to such a detection, the metal material MM can be determined to be in at least a partial liquid state or in an entirely liquid state.

For example, the one or more sensors S can provide data to a controller CTRL for the controller to utilize in the detection of at least one change of state of the metal material from between its solid state condition to its liquid state condition. This type of detection can also, or alternatively include use of a pressure sensor and/or temperature sensor for detection of sufficient heat or pressure of a hydraulic motor indicating a certain level of melting of the metal material MM within the chamber 3c for adjustment of burner operation for adjusting the flame(s) output from the burner(s) B.

The use of one or more sensors S can include use of a combination of data from different sensors being provided to a controller CTRL to evaluate the sensor data and determine a sufficient melting of metal material MM has occurred to trigger an adjustment in burner operation. The material state change determinations can be based on either absolute changes or changes in the trends of the measurement data provided to the controller CTRL via the sensor(s) S. The controller can include a determination methodology that is defined by code stored in memory 11b of the controller CTRL that defines a method by which the controller determines when burner adjustment is needed. The controller CTRL can then trigger that adjustment of the burner operation via communications with the burner(s) B, valve(s) that can supply oxidant and/or fuel to the burner(s) B, a positional adjustment mechanism of the burner(s) B, and/or communication with other process control elements for adjustment in operation of the burner(s) B. Such actions by the controller CTRL can occur automatically or after receipt of a confirmation input from an operator. In the event confirmation input from an operator may be needed, the controller can output data for being provided to the operator via a display device or operator device to facilitate receipt of such input (e.g. via a display of a notification prompt for receipt of the input, etc.).

Data from one or more sensors S can be provided to the controller CTRL to evaluate the sensor data based on a pre-defined evaluation scheme defined by code or an application that the controller CTRL can run for use in detection of a material state change to trigger actuation of an adjustment burner operation for burner(s) and/or burner element(s). For example, the pre-defined evaluation scheme can be defined by code accessible to a processor of the controller for running that code in which the code defined at least one a static model and/or at least one machine learning model. A machine learning model can include a convolutional neural network (CNN) andlor other neural network(s) for image processing and/or classification, for example. Other types of machine learning models can also be utilized (e.g. a clustering and/or regression model for data processing and prediction, etc.). In response to a detected material state change that is based on the sensor data and/or model, the controller CTRL can actuate adjustment in operation of the burner(s) and/or burner elements.

In some embodiments, the controller CTRL can determine that the metal material has entirely melted or is at least partially melted via utilization of a pre-defined model that is stored in its non-transitory memory and run via its processor. The model may utilize sensor data from one or more sensors S (e.g. temperature sensor(s), camera, laser, ultrasonic sensor, force sensor, voltage sensor, current sensor, etc.) to predict when the metal material is at least partially melted or entirely melted for actuating adjustment in burner operation (e.g. movement of one or more flames F, ceasing of outputting of a flame F via a burner B, etc.) The predictive model can be utilized to facilitate the determining of the melting of the metal material by the controller for control of the burner(s) B or other metal melting operational parameters.

The controller CTRL can adjust the operational modes of the burners B between multiple states to adjust the direction of the flame(s) and/or size and heat input of the flame(s) and/or equivalence ratio in response to the detected level of melting of the metal material. Examples of such adjustments are further discussed herein and can also be appreciated from FIGS. 2-5.

For example, in a first mode of operation in which the metal material is determined to be entirely in a solid state, the flame(s) F can be directed to the metal material MM for impingement on the material (e.g. direct contact) and/or being in close proximity to the metal material MM. Examples of such flame(s) F can be seen from the examples of FIGS. 2-5. As may be appreciated from the illustration of the flame(s) F, there can be a single flame For multiple flames F directed at the metal material MM in the chamber 3c. The flame(s) F can be directed from at least one door 3d mounted burners B that can direct the flame(s) F downwardly into the chamber 3c to be directed at the metal material MM in the chamber 3c. This type of direction of elongation of the flame(s) along the flame length of the flame(s) can include a flame F being elongated along a flame length that can extend to the upper surface of the metal material MM or in close proximity to that upper surface of the metal material MM in the chamber 3c.

For example, at least one flame F can be declined to be directed at an angle of declination from a door mounted burner B to the upper surface of the metal material MM along an angle of declination toward the upper surface of the metal material (e.g. an angle of between 15° and 75° relative to horizontal, and angle of between 30° and 60° relative to horizontal, etc. directed downwardly so the flame F extends downwardly as illustrated schematically in FIGS. 2, 3, 4, and 5).

After melting of the metal material MM is determined to have occurred to indicate that the metal material MM is no longer entirely solid state material, a second state of the metal material can be detected that includes the metal material including solid state material as well as liquid state material or that indicates the metal material MM is entirely liquid or almost entirely liquid. The operation of the burner(s) B can be adjusted from a first mode of operation to a second mode of operation in response to such a detection to alter the direction and/or size of the flame(s) F. For example, the controller CTRL can detect such an occurrence via sensor data as discussed above and communicate with valve(s), at least one positional adjustment mechanism of each burner B and/or other elements to adjust the direction of the flame(s) F and/or size of the flame(s) F to move the distal end of the flames away from the liquid state portion of the metal material MM and direct the flame(s) so that they are adjusted so a distal end of the flame(s) F is moved further away from the metal material MM. In situations where a flame F is directed at an angle of declination, this can include adjustment in the length and angle of declination of the flame(s) F to direct the flame farther away from the metal material MM.

For instance, in some embodiments, the melting of the metal material MM can be detected as further progressing to another more molten state in which a greater proportion of the metal material is in a liquid state based on sensor data being provided to the controller CTRL as discussed above (e.g. hydraulic pressure data, motor current data, motor voltage data, motor power data, force exerted sensor data, etc. in which the force needed for rotation of the chamber 3c at a pre-selected rotational speed decreases to or below a pre-selected threshold to indicate sufficient melting of metal material MM has occurred to trigger adjustment in burner operation to avoid burning of the metal material MM, etc.). Such a detection can be based on the sensor data provided to the controller CTRL as discussed above, for example. The mode of operation of the burner(s) B can be adjusted from the first mode of operation to a second mode of operation in response to such a detected change via the controller CTRL communicating to the different process elements of the apparatus 1 as discussed above (e.g. via one or more valves, at least one burner B, burner positional adjustment mechanism(s) of the burner(s) B, etc.).

For instance, the controller CTRL can detect such an occurrence via sensor data as discussed above and communicate with valve(s) controlling the flow of oxidant and/or fuel to the burner(s) B, at least one positional adjustment mechanism of each burner B and/or other elements to adjust the direction of the flame(s) F and/or size of the flame(s) F to move the distal end of the flames away from the liquid state portion of the metal material MM. In embodiments where the flame(s) F can extend at an angle of declination or a tilted angle relative to vertical, this can include adjustment in the length and angle of declination of the flame(s) F and/or adjustment in the angle of tilting relative to vertical and/or size of the flame F to direct the flame away from the metal material MM.

In some embodiments, it is contemplated that the adjustment in operation of the burner(s) B based on a detected state of the metal material can include multiple different adjustments in burner operation to account for detection of (i) a mostly or entirely solid state of the metal material MM, (ii) an intermediate solid state in which a substantial portion of the metal material is liquid and (iii) a liquid state in which the metal material is entirely liquid or almost entirely liquid. Such a detection can occur via determining that a greater proportion of the metal material is in a liquid state based on sensor data being provided to the controller CTRL as discussed above (e.g. hydraulic pressure data, motor current data, motor voltage data, motor power data, force exerted sensor data, etc. in which the force needed for rotation of the chamber 3c at a pre-selected rotational speed decreases to or below a pre-selected threshold to indicate sufficient melting of metal material MM has occurred to trigger adjustment in burner operation to avoid burning of the metal material MM, etc.). Such a detection can be based on the sensor data provided to the controller CTRL as discussed above, for example.

The mode of operation of the burner(s) B can be adjusted from the first mode of operation to a second mode of operation in response to such a first detected change via the controller CTRL communicating to the different process elements of the apparatus 1 as discussed above (e.g. via one or more valves, at least one burner B, burner positional adjustment mechanism(s) of the burner(s) B, etc.). The mode of operation of the burner(s) B can be adjusted yet again from the second mode of operation to a third mode of operation in response to a second detected change via the controller CTRL communicating to the different process elements of the apparatus 1 as discussed above (e.g. via one or more valves, at least one burner B, burner positional adjustment mechanism(s) of the burner(s) B, etc.). The threshold of a parameter or set of parameters being monitored for triggering adjustment in the operation of the burner(s) B from the second mode of operation to a third mode of operation can be a second pre-selected threshold that differs from the first pre-selected threshold to indicate a further significant reduction in needed power, pressure, current, or voltage, for instance. As another example, the second pre-selected threshold can differ from the first pre-selected threshold and indicate a surface of the metal material MM indicates that the material is entirely liquid or more liquid that warrants a change to the third mode of operation. In such a detection scheme, the first mode of operation can be associated with an initial threshold or range, the second mode of operation can be associated with a change as defined by a first pre-selected threshold or range that indicates a first lower amount of force or power is needed for rotation of the chamber 3c and/or that indicates that the metal material is at least partially melted but not entirely liquid, and the third mode of operation can be associated with a change as defined by a second pre-selected threshold or range that indicates the metal material is entirely liquid and/or that a second lower amount of force or power is needed for rotation of the chamber 3c wherein the second lower amount of force or power is lower than the first lower amount of force or power (e.g. the first lower amount of force or power is a value that is between the initial amount of force or power and the pre-selected or predetermined second lower amount of force or power).

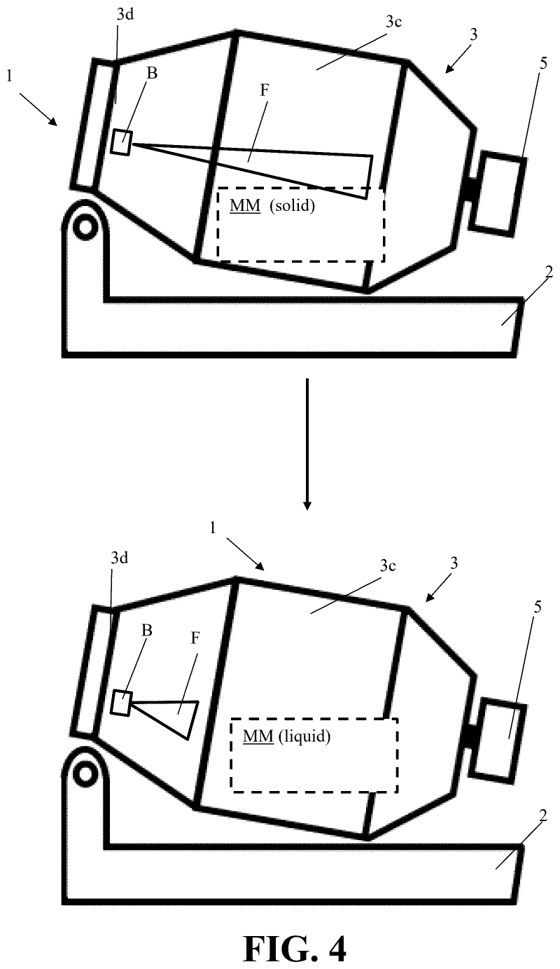

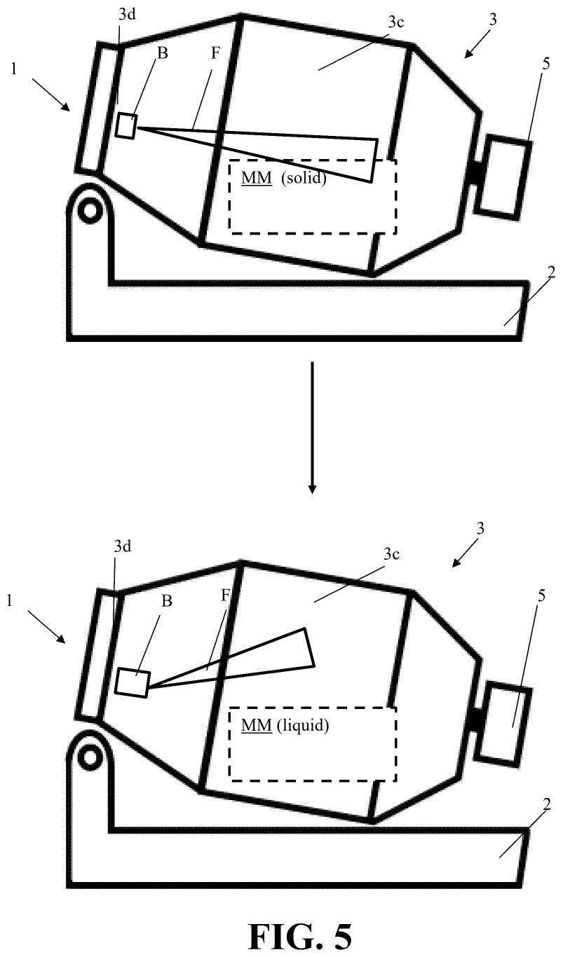

After melting of the metal material MM is determined to have occurred to indicate that the entirety of the metal material MM is in a liquid state, a final state of the metal material can be detected that includes the entirety of the metal material MM being in a liquid state. The operation of the burner(s) B can be adjusted from a first or second mode of operation to a final mode of operation in response to such a detection to alter the direction and/or size of the flame(s) F. For example, the controller CTRL can detect such an occurrence via sensor data as discussed above and communicate with valve(s) for controlling flows of oxidant and/or fuel, at least one positional adjustment mechanism of each burner B and/or other elements to adjust the direction of the flame(s) F and/or size of the flame(s) to move the distal end of the flame(s) F away from the metal material MM. In situations where a flame F is directed at an angle of declination, this can include adjustment in the length and angle of declination of the flame(s) F to direct the flame so it extends horizontally or at an angle of inclination so that the flame(s) are directed parallel to the upper surface of the metal material MM or are directed upwardly away from the upper surface of the metal material MM in the bath of the chamber 3c. Examples of this type of adjustment can be appreciated from FIGS. 4 and 5 in which a flame F is adjusted from being output to extend to be close to or impinge metal material MM so it is adjusted to be directed so the distal end of the flame F is farther from the metal material (e.g. directed upward and away from the metal material MM or shortened to be further away from the upper surface of the metal material MM). For example, the burner operation can be adjusted so the output flame(s) F can have a substantially smaller length to be positioned sufficiently far away from the upper surface of the metal material MM so that the distal end of each flame F is at least greater than 0 meters away from the upper surface and is in a position in which the flame F is unable to burn the metal material MM in the chamber 3c (e.g. is at least 0.1 meters away from the upper surface, is at least 0.5 meters away from the upper surface, etc.) as indicated by FIG. 4, for example. As another example, the burner operation can be adjusted so the output flame(s) F can have a substantially similar length but have its angle of inclination adjusted to be directed upward away from the metal material MM instead of downwardly directed at the metal material so that the flame F is positioned sufficiently far away from the upper surface of the metal material MM so that the distal end of each flame F is at least greater than 0 meters away from the upper surface and is in a position in which the flame F is unable to burn the metal material MM in the chamber 3c (e.g. is at least 0.1 meters away from the upper surface, is at least 0.5 meters away from the upper surface, etc.) as indicated by FIG. 5, for instance

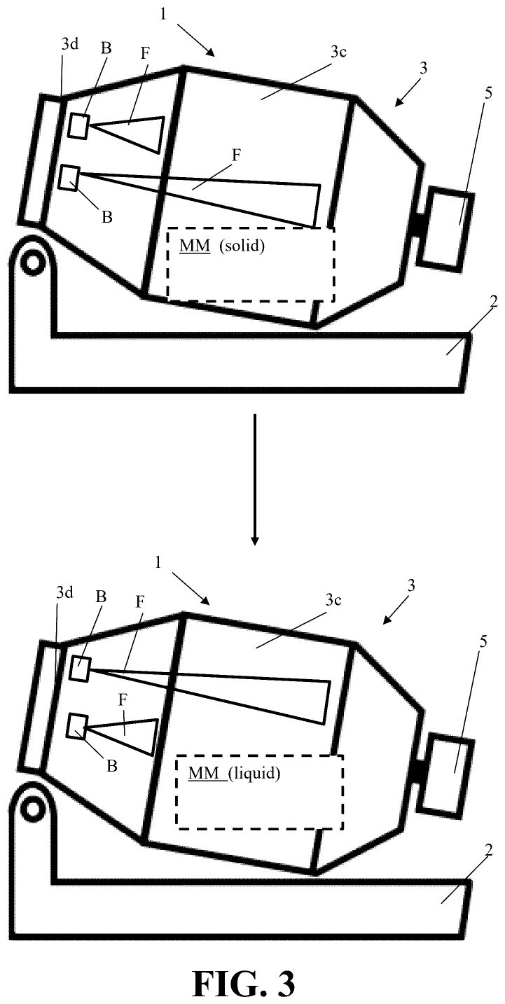

A further example of such an adjustment in which burner operation can be adjusted so that one or more flames F are adjusted away from the upper surface of the metal material MM can be appreciated from FIGS. 2 and 3. For instance, as can be seen in the example of FIG. 3, in embodiments that can utilize multiple burners B that can include a first lower burner B and a second upper burner B that are mounted to the door 3d of the rotatable body 3b, the controller CTRL can control burner operation B to adjust how the burners B operate in conjunction with one or more monitored parameters measured or detected by one or more sensors S. For instance, in a first mode of operation in which the metal material is determined to be entirely in a solid state, a flame F output from a lower burner B can be directed to the metal material MM for impingement on the material (e.g. direct contact) and/or being in close proximity to the metal material MM (e.g. within 1 meter, within 0.5 meters, within 0.1 meters, etc.). Also, in the first mode of operation in which the metal material MM is determined to be entirely in a solid state, a flame F output from the upper burner B can be directed to be above the metal material MM and spaced away from the metal material MM. FIGS. 2 and 3 each illustrate such a type of configuration for operation of the burners B.

After detection of a first detected change via the controller CTRL communicating to the different process elements of the apparatus 1 (e.g. at least one sensor S) as discussed above, it can be determined that the metal material has sufficiently melted to trigger adjustment in operation of the burners B. The controller CTRL can be configured to respond to such a determination that is based on the sensor data to adjust burner operation via communication with one or more process control elements and/or the burner(s) B (e.g. via one or more valves, at least one burner B, burner positional adjustment mechanism(s) of the burner(s) B, etc.). The mode of operation of the burner(s) B can be adjusted from a first mode of operation to a second mode of operation in response to the detected change via the controller CTRL communicating to the different process elements of the apparatus 1 as discussed above. As may be appreciated from FIG. 2, this adjustment can result in the first lower burner B being adjusted so it no longer outputs a flame. Alternatively, this may result in the controller CTRL communicating with the first lower burner B to adjust its operation so the flame F output from this burner B is shorter and/or adjusted in inclination to move the distal end of the flame F and/or flame F away from the upper surface of the metal material MM in the chamber 3c as shown in FIG. 3. Also, this adjustment in burner operation can result in the second upper burner B being adjusted so it outputs a longer flame F and/or a flame that is longer and also otherwise adjusted to be positioned closer to the metal material MM within the chamber 3c, but also positioned such that the flame F output from the second upper burner B is still positioned farther away from the upper surface of the metal material MM in the chamber 3c as compared to the flame F output from the first lower burner B when operating in the first operational mode.

During melting of the metal material, the controller CTRL can be configured to control operation of the burner(s) B so that the burner(s) B operate within a pre-selected range of equivalence ratios and/or firing rates. The operational ranges can be different for different burners B as well.

For instance, the equivalence ratio for burner(s) B located closer to the metal material (e.g. in a lower position when mounted to a door 3d as compared to other burners B positioned on the door 3d above the lower burner B) to be melted in a bath of the chamber 3c can range from 0.5 to 5, 0.95 to 5 or 1 to 3.75 in different embodiments. At the beginning of a melt operation (e.g. at an initial phase in which the metal material is solid state), a higher equivalence ratio may be utilized for such burner(s) and/or burner element(s) (e.g. an equivalence ratio of 5, 3.75, or other value at a higher end of a pre-selected operational range of equivalence ratios). At the end of a melt operation in which the metal material is liquified, a lower equivalence ratio may be utilized (e.g. an equivalence ratio of 0.5, 0.95, 1.0, or other value at a lower end of a pre-selected operational range of equivalence ratios).

For burner(s) B that are farther away from the metal material MM to be melted (e.g. closer to a top of the door 3d, etc.) the equivalence ratio for the burner(s) B can range from 0.1 to 1, 0.25 to 1 or 0.2 to 1 in different embodiments, for example. At the beginning of a melt operation (e.g. at an initial phase in which the metal material is solid state), a lower equivalence ratio may be utilized (e.g. an equivalence ratio of 0.1, 0.2, 0.25, 0.36, 0.4, or other value at a lower end of a pre-selected operational range of equivalence ratios). At the end of a melt operation in which the metal material is liquified, a higher equivalence ratio may be utilized (e.g. an equivalence ratio of 1, 0.9, 0.95, or other value at a higher end of a pre-selected operational range of equivalence ratios).

The controller CTRL can adjust parameters so that the burners B can also be operated such that the equivalence ratio of all burner(s) B utilized in the melting of the metal material can operate at an overall combined equivalence ratio within a pre-selected range of ratios (e.g. an overall combined equivalence ratio range of 1-1.1, 0.9-1.2, 0.95-1.15, etc.). The selected operational equivalence ratios can be selected to account for the chamber 3c and burner configurations, fuel to be combusted, the type of metal material to be melted, and the presence of any combustible contaminants.

Burner B firing rates can also be pre-selected to account for where the burner(s) and/or burner elements are located relative to the material to be melted and other design and operational objectives. For instance, for burner(s) B located closer to the metal material MM (e.g. at a lower position on the door 3d) to be melted in a chamber 3c, their firing rate allocation can be within a pre-selected range of 10%-90%, 50%-90% or 70%-80% of maximum firing rate, for example. At the beginning of a melt operation (e.g. at an initial phase in which the metal material is solid state), a higher firing rate allocation may be utilized (e.g. burning rate allocation of 70%-80%, or 50%-90%, or other value at a higher end of a pre-selected operational range of firing rate allocations). At the end of a melt operation in which the metal material is liquified, a lower firing rate allocation may be utilized (e.g. a firing rate allocation of 20%-30%, 10%-50%, or other value at a lower end of a pre-selected operational range of firing rate allocations).

For burner(s) B that are farther away from the metal material MM to be melted (e.g. closer to a roof of the chamber 3c above the lower burner(s) B, etc.) the range of firing rate allocations for such burner(s) and/or burner element(s) can range from 10% to 90%, 20%-80%, or other pre-selected firing rate allocation range in different embodiments, for example. At the beginning of a melt operation (e.g. at an initial phase in which the metal material is solid state), a lower firing rate allocation may be utilized (e.g. a firing rate allocation of 20%-30%, a firing rate allocation of 10%-50%, or other value at a lower end of a pre-selected operational range of firing rate allocations). At the end of a melt operation in which the metal material is liquified, a higher firing rate allocation may be utilized (e.g. firing rate allocation of 70%-80%, 50%-90%, or other value at a higher end of a pre-selected operational range of firing allocation ratios).

At or near the end of a melting operation in which the metal material is liquified, the firing rate may decrease further as the end of the melt operation approaches. And the firing of the burners B can also, in some embodiments, be ceased after a full melt has occurred in some embodiments.

Table 1 provided below provides an additional example of exemplary pre-selected equivalence ratio ranges and burner firing rate ranges that can be utilized in different embodiments.

TABLE 1
exemplary range of equivalence ratios and firing rate ranges for a
transient burner with two or more elements or two or more burners B

| | | Later stages of melting |
|---|---|---|
| Burner Location | | (material is more |
| or Burner Element | Initial stages of | liquified or fully |
| Orientation | melting | liquified) |
| Closer to material | Firing rate allocation | Firing rate allocation |
| to be melted | of 70%-80% | of 20%-30% |
| | Equivalence Ratio | Equivalence Ratio |
| | of 2-3.75 | of 1-2 |
| Further from material | Firing rate allocation | Firing rate allocation |
| to be melted (e.g. | of 20%-30% | of 70%-80% |
| closer to roof) | Equivalence Ratio | Equivalence Ratio |
| | of 0.25-0.5 | of 0.5-1.0 |

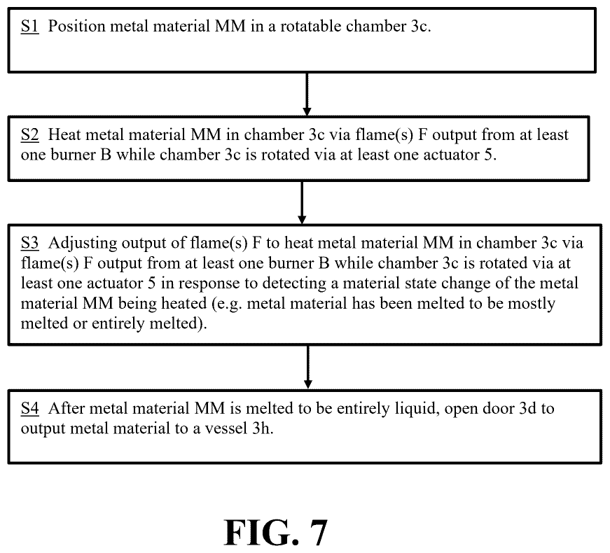

FIGS. 2-5 illustrates embodiments of a process for melting metal material MM, which can utilize an exemplary embodiment of a process for controlling at least one flame F for the melting of metal material. Embodiments of the apparatus 1 and embodiment of a control system 21 for the apparatus 1 can be configured to utilize an embodiment of this process. FIG. 7 also illustrates yet another embodiment of such a method for melting metal material MM that can utilize an embodiment of the apparatus 1 and/or control system 21.

As may be appreciated from FIG. 7, as well as FIGS. 2-5, in a first step S1, solid metal material MM can be positioned in a rotatable chamber 3c of an apparatus 1 for being heated via at least one flame F generated via at least one burner B. The solid metal material MM can be fed into the chamber 3c via opening of a door 3d.

After the metal material is fed into the opened chamber 3c via the opened door 3d, the door 3d can be closed to enclose the chamber 3c and the burner(s) B can subsequently be started to initiate combustion of a fuel to form at least one flame F for heating the metal material MM in the chamber 3c in a second step S2. At this initial heating of the metal material MM, the material can be determined to be in a solid state and each flame F, or at least one of the flames F, can be directed to a tallest region of the upper surface of the metal material MM in the chamber 3c for heating of the metal material MM that is in a solid state for melting that material. Examples of such a direction of the flame(s) F can be appreciated from FIGS. 2-5, for example. Such a direction of the flame(s) F can result in a distal end of the flame impinging on the metal material MM or in being within 1 meter, within 0.5 meters, within 0.2 meters, or within 0.1 meters of the metal material MM.

In a third step S3, the flame(s) F can be adjusted to direct the flame(s) F farther away from the metal material MM. This third step S3 can include detection of at least one intermediate melting stage of the metal material for adjustment of the burner operation for adjustment of the flame(s) F as discussed above, for example. This third step S3 can also, or alternatively, include a determination that the metal material MM has been fully melted into a liquid state. As discussed above, the determination of the change in sate of the metal material can be detected via sensor data from at least one sensor S indicating that less force or power is needed for rotation of the chamber 3c at a pre-selected rotational speed.

The third step S3 can include a single adjustment or can include multiple different discrete adjustments that account for different pre-selected or pre-defined stages of the melting process for the melting of the metal material in which a portion of the material is melted into a liquid state and a portion of the material is still in a solid state as discussed above. The detection of the melting stage(s) of the metal material can be provided via use of one or more sensors S and a controller CTRL as discussed above (e.g. utilization of sensor data, utilization of a predictive model defined in memory of the controller, etc.). The adjustment in operation of the burner(s) B to provide the flame adjustment can also be performed as discussed above in some embodiments.

In the third step S3, the flame(s) F can be adjusted so that the flame(s) move away from the upper surface of the metal material MM in response to detection of the metal material being entirely in a liquid state. The detection of the entirely melted state of the metal material can be provided via use of one or more sensors S and a controller CTRL as discussed above. The adjustment in operation of the burner(s) B to provide the flame adjustment can also be performed as discussed above in some embodiments (see e.g. FIGS. 2-5).

In a fourth step S4, after the metal material MM is determined to be entirely liquid and sufficiently melted, the burner operation can be ceased entirely, the door 3d can be opened and the chamber 3c can be tilted to pour the metal material out of the chamber 3c and into a vessel 3h via the opened door 3d or the metal material can be output from the chamber 3c in another manner (e.g. removal or adjustment of a plug so the metal material can be drained from the chamber 3c, etc.). The rotation of the chamber 3c can also be ceased to facilitate pouring of the melted metal material MM or removal of the melted metal material from the chamber 3c. A new batch of metal material MM can then be fed into the chamber 3c to undergo melting therein. The process of melting the new batch of metal material MM can include use of steps S1-S4 as discussed above.

In some embodiments, a portion of the metal material MM that is liquid from the prior melt operation may be retained in the chamber 3c for receiving the new batch of metal material to be melted. This remaining portion of metal material MM can be utilized to help retain some heat in the furnace to facilitate melting of the new batch of metal material MM.

Embodiment of the process can also include other steps. For example, embodiments can include utilizing the melted metal material fed to the vessel 3h to form an article or ingot. As another example, embodiments can include a controller CTRL communicating with different process elements for adjusting the flame(s) F to account for intermediate melting stages as discussed above. Embodiments of the process can also include other features or steps.

The adjustment in the operation of the burner(s) B can adjust the length of the flame(s) F, the direction of the flame(s) F, and/or the firing rate of the burner(s) B to account for the material state of the metal material MM being melted to help avoid burning of the metal material MM while also providing improved use of the heat of the generated flame(s) F. Embodiments can provide greater flexibility in operation for a more refined control of melting of metal material MM to help avoid burning the metal while also improving utilization of energy so that a more efficient and flexible operation can be provided in a way that may also improve the environmental impact related to operation of the furnace and the melting of metal. Improved yield at lower overall use of energy and/or fuel can be provided, for example, which can help reduce the environmental impact associated with operations.

Control in operation of the burner(s) B and other elements of the apparatus 1 can also be updated to account for empirical use conditions that are observed via a control system 21 during operations. Such empirical data can be collected via sensor data and other data and provided to a control evaluation device HIST. The HIST can be a type of computer device 10 that can be communicatively connected to a controller CTRL for evaluation of empirical data via one or more pre-defined evaluation schemes and provide data to the controller CTRL based on such an evaluation for updating one or more control parameter settings (e.g. setpoints, thresholds, etc.) of the controller CTRL. An operator may be prompted to review and approve such an adjustment before it is implemented in the controller CTRL via a communication provided by the control evaluation device HIST or the controller CTRL (e.g. via a communication provided to an operator device, via a notification provided to an operator device, etc.).

In other embodiments, the controller CTRL can be configured to store such data and evaluate such data via one or more pre-defined evaluation schemes for updating one or more control parameters or providing output to an operator for the operator to approve an updating of one or more control parameters based on the conducted evaluation of stored, empirical data.

The evaluation of empirical data and updating of control parameters can be configured to update one or more control parameters, which can include pre-selected setpoints or pre-selected thresholds for controlling (a) flow rates, (b) equivalence ratios, (c) flame position, (d) flame orientation, (e) flame mode, (f) burner allocation, or combinations of such parameters. The one or more control parameters can also relate to other operations of other aspects of the apparatus 1.

The data for different control parameters as well as data for other uncontrolled parameters such as but not limited to material details (size, shape, impurities, description, supplier, etc.), material amounts, rotation speed, starting weights, liquid metal from prior cycle, ambient condition, furnace temperatures and conditions, etc. can be used to perform at least one pre-defined evaluation scheme for evaluation of performance in melting of metal and identifying control parameter changes that may be made to improve operations to account for empirical use data. Such data can include sensor data as well as other data related to melting of metal material that may be provided by other sensors or control device.

The pre-defined evaluation scheme can include one or more types of schemes. For example, a pre-defined evaluation scheme can include modeling of a

$$Solid Temperature Change over Time \frac{{dT}_{S}}{dt} ,$$

$$Liquid Temperature Change over Time \frac{{dT}_{L}}{dt} ,$$

$$Solid Energy Change over Time \frac{{dQ}_{S}}{dt} ,$$

$$Liquid Energy Change over Time \frac{{dQ}_{L}}{dt} ,$$

and/or other conditions. Other conditions, can include, for example, State Change Time or a percentage of overall time in which a state change occurred for a melt, Material Yield Recovery, overall melt time, an amount of time metal being melted was determined to be in different material states (solid, partially melted, fully melted, etc.), a time for each cycle in a melting process, an amount of energy utilized in each cycle of the melting process, or other modeling approaches. In some embodiments, the pre-defined evaluation scheme can utilize a single pre-defined model or a combination of multiple different models. Models can include physics-based modeling, machine learning models, a blend of these models with single or multiple x-values and y-values, or a combination of such models. Utilizing these model(s) with a control parameter search can help determine the optimal material temperature increase at each cycle step and/or temperature phase, optimal yield recovery, optimal overall melt time, reduced energy, and reduce environmental impact based on empirical metal melting data for use in updating of one or more control parameters that can be utilized by the controller CTRL.

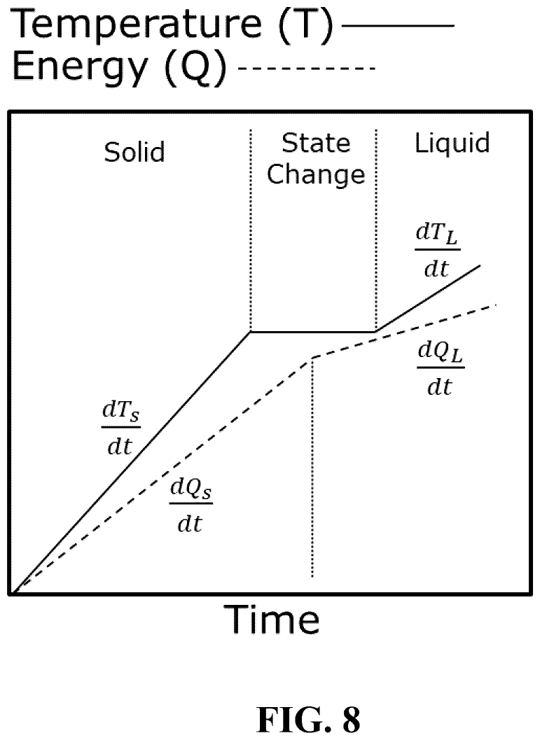

As may be appreciated from FIG. 8, an example control model can be broken down into three or more temperature phases such as but not limited to solid, state change, and liquid. When the metal material MM is entirely solid or mostly solid it can absorb more energy and is less likely to burn and create dross. The model can be defined so that a slope of solid material temperature (Tₛ) changing over time

$$( t ) - > \frac{{dT}_{s}}{dt} .$$

The data for this slope that can be determined can be based on the temperature data received from one or more sensors S during prior melts for a time period in which the metal material MM was determined to be in a solid state (e.g. prior to a change in adjustment of a burner B for adjusting in flame positioning, etc.). A steep

$$\frac{{dT}_{S}}{dt}$$

slope may result in a reduced cycle time and improve energy efficiency and a gradual

$$\frac{{dT}_{S}}{dt}$$

slope (e.g. less steep slope) may result in an increased cycle time and reduce energy efficiency. A comparison of such slopes from multiple different prior melting cycles can be utilized to help identify control parameters adjustments that may allow for a quicker melt that is more energy efficient while also avoiding the burning of the metal material to be melted.

The model can also be defined so that when the material is in the state change phase, temperature may change minimally as most of the energy is utilized by melting of the materials. The determination of such a phase can be based on the sensor data received from prior melts and evaluation of when the metal material being melted changed from being partially solid and partially liquid to entirely liquid (e.g. a non-significant change in temperature while the material undergoes heating or changes in force needed for rotation (e.g. via at least one hydraulic pressure sensor, use at least one motor current sensor, use at least one voltage sensor, use at least one motor power sensor, use at least one rotational force sensor, etc. as discussed above) or changes in the surface of the materials in the furnace (e.g. via at least one ultrasound sensor, at least one imaging sensor (e.g. at least one camera), or other type of sensor or combination of sensors (e.g. use of a temperature sensor, use at least one temperature sensor at a pre-selected position for measuring temperature at a particular location in the furnace, etc. as discussed above).). The risk of burning the metal can increase in this phase as some of the material is in the liquid phase. This condition to be monitored and evaluated can be defined as the slope of liquid material temperature (T_{L}) changing over time

$$( t ) -> \frac{{dT}_{L}}{dt} .$$

Since the time the material is in a solid phase may be much greater than when the material is in a liquid phase, a steep

$$\frac{{dT}_{L}}{dt}$$

slope may provide little to no cycle time improvements but may increase the risk of burning aluminum and a more gradual

$$\frac{{dT}_{L}}{dt}$$

slope may decrease the risk of burning aluminum and improve yield recovery.

Another example control model that can be utilized in a pre-defined evaluation scheme can include defining two or more energy phases such as but not limited to solid energy phase and liquid energy phase wherein the state change (e.g. transition between entirely solid to entirely liquid) is split between these energy phases. When the metal material is in a solid energy phase, it can absorb more energy and is less likely to burn and create dross. This can be defined as the slope of solid material energy (Qₛ) increasing/changing over time

$$( t ) -> \frac{{dQ}_{S}}{dt} .$$

A steep

$$\frac{{dQ}_{S}}{dt}$$

slope can reduce cycle time while a more gradual

$$\frac{{dQ}_{S}}{dt}$$

slope can increase cycle time but may have other benefits.

At the end of the solid energy phase material melting has already started. At the beginning of the liquid energy phase the material is still melting but the risk of metal burning has increased. This can be defined as the slope of liquid material energy (Q_{L}) changing over time

$$( t ) -> \frac{{dQ}_{L}}{dt} .$$

Since the time the material is in a solid energy phase may be much greater than when the material is in a liquid phase, a steep

$$\frac{{dQ}_{L}}{dt}$$

slope may provide little to no cycle time improvements but may increase the risk of burning the metal material and a gradual

$$\frac{{dQ}_{L}}{dt}$$

slope may decrease the risk of burning the metal and improve yield recovery but could be dependent on other factors.

The transition between entirely solid phase to entirely liquid phase can be determined as being a period of time in which the temperature of the metal material does not substantially change while it is undergoing heating (e.g. horizontal portion of line shown in FIG. 8).

The control evaluation device can be configured to utilize the collected data from prior operations of the apparatus to model that data and identify adjustments in control parameters that may provide improved operations (e.g. improved yield and/or reduced energy consumption and/or reduced processing time, etc.) while the metal material is in the solid phase, liquid phase, or undergoing a transition from solid to liquid. For example, adjustments in one or more control parameters can be identified for reducing the

$$\frac{{dQ}_{L}}{dt}$$

slope or reducing the

$$\frac{{dT}_{L}}{dt}$$

slope. As another example, adjustments in one or more control parameters can be identified for increasing the

$$\frac{{dQ}_{S}}{dt}$$

slope or increasing the

$$\frac{{dT}_{S}}{dt}$$

slope. Such adjustments can include adjustments of control parameters that may be utilized by the controller CTRL for determining when metal material MM is solid, no longer entirely solid or is entirely liquid, control parameters used by the controller CTRL for controlling burner and/or burner element operation (e.g. flame size, flame direction, equivalence ratio, etc.), or other control parameters.

The detected adjustments in operational setpoints, thresholds utilized for detection of a metal material state, or other control parameters that are identified from such an evaluation can be communicated to a controller CTRL for updating those setpoints, thresholds, or other control parameters. The controller CTRL or control evaluation device HIST can be configured to provide a prompt to an operator for receipt of input that approves of such a change or such changes before the controller CTRL implements the change(s). These types of control parameter adjustments can permit the adjustment in flame(s) output from the burner(s) to occur in a more efficient manner via more precise detection of the phase of the metal material and/or a more precise modeling or correlation of how adjusting the positioning of the flame(s) impacts the condition of the metal material and overall furnace operation.

Embodiments of the apparatus 1 and process can include other features or elements. For instance, embodiments of the apparatus or process can each be configured to include process control elements positioned and configured to monitor and control operations of the apparatus 1 and/or process of melting metal material (e.g. temperature and/or pressure sensors, flow sensors, optical sensors, ultrasound sensors, etc., an automated process control system having at least one work station that includes a processor, non-transitory memory and at least one transceiver for communications with the sensor elements, valves, and controllers for providing a user interface for an automated process control system that may be run at the work station and/or another computer device of the plant, etc.). It should be appreciated that embodiments can utilize a distributed control system (DCS) for implementation of one or more processes and/or controlling operations of an apparatus or process as well.

The burner(s) B that may be utilized in the apparatus 1 can be any type of suitable burner B. For example, burners, oxy-fuel burners, transient burners with multiple burner elements, or a combination of such burners can be utilized. Also, the metal material to be melted can be any suitable metal. For example, the metal material to be melted can include aluminum or another type of metal or can include an alloy (e.g. brass or bronze). For example, the metal material MM can include aluminum, copper, lead, tin, brass, steel, iron, or other suitable metal material. Also, the size and configuration of the rotatable chamber 3c can be any suitable geometry or size to meet a pre-selected set of design criteria.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a process, an apparatus, a system, and methods of making and using the same have been shown and described above, it is to be distinctly understood that the invention is not limited thereto but may be otherwise variously embodied and practiced within the scope of the following claims.

1. A process for melting metal material comprises:
directing at least one flame to metal material in a rotating chamber such that the at least one flame impinges the metal material or is within a pre-selected distance that is no greater than 1 meter from the metal material while an entirety of the metal material is in a solid state;
in response to detecting that the metal material has melted such that the metal material is at least in a partially liquid state, adjusting the at least one flame to move the at least one flame away from the metal material or deactivating an output of the at least one flame.

2. The process of claim 1, wherein the adjusting of the at least one flame to move the at least one flame away from the metal material comprises shortening of the at least one flame to avoid burning of the metal material, adjusting a firing rate of the at least one burner that outputs the at least one flame, and/or adjusting operation of the at least one burner so that the at least one flame extends horizontally relative to an upper surface of the metal material and above the upper surface.

3. The process of claim 1, wherein the adjusting of the at least one flame to move the at least one flame away from the metal material comprises adjusting operation of at least one burner that outputs the at least one flame so that the at least one flame extends at an angle of inclination away from an upper surface of the metal material.

4. The process of claim 1, wherein the adjusting of the at least one flame to move the at least one flame away from the metal material comprises adjusting operation of at least one burner that outputs the at least one flame so that the at least one flame is shorter.

5. The process of claim 1, comprising:
detecting that the metal material has melted such that the metal material is at least in a partially liquid state based on a detection that an amount of force, pressure, power, voltage, and/or current used to rotate the chamber has decreased to a pre-selected threshold value or decreased by a pre-selected threshold value.

6. The process of claim 5, comprising:
detecting that the metal material has melted such that the metal material is at least in a partially liquid state based on a detection that an amount of hydraulic pressure utilized to rotate the chamber has decreased to a pre-selected threshold value or decreased by a pre-selected threshold value.

7. The process of claim 1, comprising:
detecting that the metal material has melted such that the metal material is entirely in the liquid state, the detecting that the metal material has melted such that the metal material is entirely in the liquid state including a controller receiving data from at least one sensor positioned to detect or monitor at least one parameter associated with an amount of force or power used for rotation of the rotatable body.

8. The process of claim 1, comprising.
detecting that the metal material has melted such that the metal material is at least in the partially liquid state, the detecting that the metal material has melted such that the metal material is at least in the partially liquid state including a controller receiving data from at least one sensor positioned to detect or monitor at least one parameter associated with a surface of the metal material in the rotating chamber.

9. The process of claim 1, comprising:
detecting that the metal material has melted such that the metal material is at least in the partially liquid state, the detecting that the metal material has melted such that the metal material is at least in the partially liquid state including a controller running a model defined in non-transitory memory of the controller to predict that the metal material is at least in the partially liquid state based on sensor data received by the controller.

10. The process of claim 1, wherein:
the adjusting the at least one flame to move the at least one flame away from the metal material includes adjusting operation of a lower burner mounted to a door of a rotatable body that defines the chamber and the process also comprises:
adjusting operation of an upper burner mounted to the door to account for the adjusting of the operation of the lower burner, the upper burner being above the lower burner.

11. An apparatus for melting metal material comprising:
a rotatable body having a chamber sized to receive metal material for melting of the metal material;
at least one burner positionable adjacent to the chamber to output at least one flame for melting of the metal material that is positionable in the chamber;
a controller having a processor connected to a non-transitory computer readable medium, the controller communicatively connectable to at least one sensor and the at least one burner;
the controller configured to:
control operation of the at least one burner so that the least one flame impinges an upper surface of the metal material or is within a pre-selected distance that is no greater than 1 meter from the metal material while an entirety of the metal material is in a solid state; and
determine that the metal material has melted such that the metal material is at least in a partially liquid state liquid state based on sensor data received from the at least one sensor, and, in response to determining that the metal material is at least partially in the liquid state, control operation of the at least one burner to adjust the at least one flame to move the at least one flame away from the metal material.

12. The apparatus of claim 11, wherein the controller is configured to control operation of the at least one burner to adjust the at least one flame to move the at least one flame away from the metal material via shortening of the at least one flame to avoid burning of the metal material, adjusting a firing rate of the at least one burner, ceasing an outputting of the at least one flame via the at least one burner, and/or adjusting operation of the at least one burner so that the at least one flame is positioned at a greater distance from the metal material within the chamber.

13. The apparatus of claim 11, wherein controller is configured to control operation of the at least one burner to adjust the at least one flame to move the at least one flame away from the metal material via adjusting operation of at least one burner so that the at least one flame extends at an angle of inclination away from the metal material.

14. The apparatus of claim 11, wherein controller is configured to control operation of the at least one burner to adjust the at least one flame to move the at least one flame away from the metal material via adjusting operation of at least one burner so that the at least one flame is shorted to be positioned further away from the metal material and above the upper surface.

15. The apparatus of claim 11, wherein the at least one sensor is positioned and configured to provide the sensor data to the controller to monitor an amount of power, force, hydraulic pressure, voltage, or current used to rotate the rotatable body.

16. The apparatus of claim 11, wherein the at least one sensor is positioned and configured to provide the sensor data to the controller, the at least one sensor comprising:
a current sensor, a voltage sensor, a motor power sensor, a rotational force sensor, an ultrasound sensor, an imaging sensor, a camera, a laser, and/or an ultrasonic sensor.

17. The apparatus of claim 11, also comprising:
at least one actuator positioned to drive rotation of the rotatable body at a pre-selected rotational speed; and/or
a vessel positionable adjacent a moveable door connected to the rotatable body.

18. The apparatus of claim 11, wherein the controller has a model defined in the non-transitory computer readable medium of the controller to predict that the metal material is at least in the partially liquid state based on the sensor data that is receivable by the controller, the controller determining that the metal material is at least partially in the liquid state based on running the model to predict that the metal material is at least in the partially liquid state.

19. A control system comprising:
a controller having a processor connected to a non-transitory computer readable medium, the controller communicatively connectable to the at least one sensor and at least one burner positioned to output at least one flame to melt metal material within a rotatable chamber;
the controller configured to
control operation of the at least one burner so that the least one flame impinges an upper surface of the metal material or is within 1 meter of the upper surface of the metal material while an entirety of the metal material is in a solid state; and
determine that the metal material has melted such that the metal material is at least in a partially liquid state based on sensor data received from the at least one sensor, and, in response to determining that the metal material is in the at least partially liquid state, control operation of the at least one burner to adjust the at least one flame to move the at least one flame away from the metal material or cease outputting of the at least one flame.

20. The control system of claim 19, comprising:
a control evaluation device communicatively connectable to the controller, the control evaluation device having a processor connected to a non-transitory computer readable medium; and
the control evaluation device configured to evaluate operational data from melting of metal material that occurred in prior melting operations based on at least one pre-defined control evaluation scheme to identify one or more control parameter adjustments and communicate data to adjust the one or more control parameters to be utilized by the controller based on results from implementation of the at least one pre-defined control evaluation scheme indicating that the one or more control parameter adjustments will improve yield, increase production, and/or reduce energy consumption for melting of the metal material.
